(19) United States
(12) Patent Application Publication
(10) Pub. No.: US 2026/0353459 A1
(43) Pub. Date: Nov. 5, 2026

(54) ACCESS POINT (AP)-ASSISTED ANCHOR CHANNEL MEDIUM SYNCHRONIZATION

(71) Applicant: Ofinno, LLC, Reston, VA (US)

(72) Inventors: Leonardo Alisasis Lanante, Reston, VA (US); Jeongki Kim, Fairfax, VA (US); Esmael Hejazi Dinan, McLean, VA (US); Serhat Erkucuk, Reston, VA (US); Jiayi Zhang, Rockville, MD (US); Tuncer Baykas, Reston, VA (US)

(73) Assignee: Ofinno, LLC, Reston, VA (US)

(21) Appl. No.: 19/721,292

(22) Filed: Jun. 26, 2026

Related U.S. Application Data
(63) Continuation of application No. PCT/US2024/062029, filed on Dec. 27, 2024.
(60) Provisional application No. 63/616,112, filed on Dec. 29, 2023.

(51) Int. Cl. H04W 74/0816; H04W 8/22; H04W 74/08

(52) U.S. Cl. CPC H04W 74/0816; H04W 8/22; H04W 74/0891

(57) ABSTRACT

A first station (STA) receives, from a second STA and via a primary channel, a first frame comprising: an indication of a frame type of the first frame, and an indication of a duration of a transmission following the first frame. After receiving the first frame, based on the frame type, the first STA switches a channel of operation, from the primary channel to a secondary channel. The first STA transmits, via the secondary channel, at a transmission start time based on the duration of a transmission, a second frame. The first STA switches from the secondary channel to the primary channel after the duration.

### CROSS-REFERENCE TO RELATED APPLICATIONS

This application is a continuation of International Application No. PCT/US2024/062029, filed Dec. 27, 2024, which claims the benefit of U.S. Provisional Application No. 63/616,112, filed Dec. 29, 2023, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3 illustrates an example of a Medium Access Control (MAC) frame format.

FIG. 4 illustrates an example trigger frame.

FIG. 5 illustrates an example multi-user request to send (MU-RTS) trigger frame.

FIG. 6 illustrates an example common info field.

FIG. 7 illustrates an example of a Request-to-Send (RTS)/Clear-to-Send (CTS) procedure.

FIG. 8 illustrates an example of a wideband RTS/CTS procedure.

FIG. 9 illustrates an example of a wideband RTS/CTS procedure that uses a bandwidth signaling RTS frame.

FIG. 10 is an example that illustrates an MU-RTS/CTS procedure.

FIG. 11 is an example that illustrates a multiple primary channel (MPC)/non-primary channel access (NPCA) STA operation.

FIG. 12 illustrates virtual and physical carrier sense (CS) functions associated with primary and secondary channels for an MPC/NPCA STA and a non-MPC/non-NPCA STA.

FIG. 13 is an example that contrasts the operation of a concurrent CCA MPC/NPCA STA and the operation of a non-concurrent CCA MPC/NPCA STA.

FIG. 14 is another example that contrasts the operation of a concurrent CCA MPC/NPCA STA and the operation of a non-concurrent CCA MPC/NPCA STA.

FIG. 15 illustrates an example procedure which may be performed by an AP in some circumstances.

FIG. 16 illustrates an example procedure that illustrates a problem that may arise in some circumstances by the operation of MPC/NPCA STAs and non-MPC/non-NPCA STAs.

FIG. 17 illustrates an example procedure which may be performed by an embodiment, in a system with MPC/NPCA components.

FIG. 18 illustrates an example procedure which may be performed by MPC/NPCA components, according to an embodiment.

FIG. 19 illustrates an example procedure which may moderate interactions between MPC/NPCA components in a wireless network, according to an embodiment.

FIG. 20 illustrates an additional example procedure which may moderate interactions between MPC/NPCA components in a wireless network, according to an embodiment.

FIG. 21 illustrates an example process according to an embodiment.

FIG. 22 illustrates another example process according to an embodiment.

FIG. 23 illustrates another example process according to an embodiment.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages are presented for example purposes only. The disclosed architecture is sufficiently flexible and configurable, such that it may be utilized in ways other than those shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, may be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={STA1, STA2} are: {STA1}, {STA2}, and {STA1, STA2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g., hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers, and microprocessors are programmed using languages such as assembly, C, C++, or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

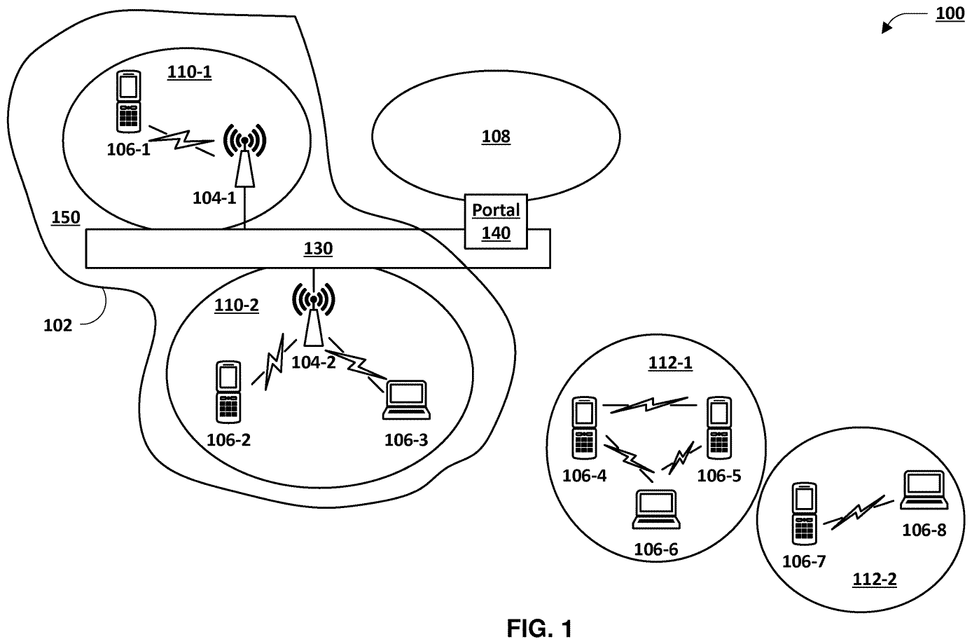

FIG. 1 illustrates example wireless communication networks in which embodiments of the present disclosure may be implemented.

As shown in FIG. 1, the example wireless communication networks may include an Institute of Electrical and Electronic Engineers (IEEE) 802.11 (WLAN) infra-structure network 102. WLAN infra-structure network 102 may include one or more basic service sets (BSSs) 110 and 120 and a distribution system (DS) 130.

BSS 110-1 and 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STAs 106-2 and 106-3. The AP and the at least one STA in a BSS perform an association procedure to communicate with each other.

DS 130 may be configured to connect BSS 110-1 and BSS 110-2. As such, DS 130 may enable an extended service set (ESS) 150. Within ESS 150, APs 104-1 and 104-2 are connected via DS 130 and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSSs). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STAs 106-4, 106-5, and 106-6 may be configured to form a first IBSS 112-1. Similarly, STAs 106-7 and 106-8 may be configured to form a second IBSS 112-2. Since an IBSS does not include an AP, it does not include a centralized management entity. Rather, STAs within an IBSS are managed in a distributed manner. STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PHY service data unit (PSDU). For example, the PSDU may include a PHY preamble and header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax and/or 802.11be standard amendments may be transmitted over the 2.4 GHz, 5 GHz, and/or 6 GHz bands, each of which may be divided into multiple 20 MHz channels. The PPDUs may be transmitted over a physical channel having a minimum bandwidth of 20 MHz. Larger channels may be optionally formed through channel bonding of a primary 20 MHz channel and one or more 20 MHz secondary channels. For example, PPDUs may be transmitted over physical channels having bandwidths of 40 MHz, 80 MHz, 160 MHz, or 320 MHz by bonding together a primary 20 MHz channel and 1, 3, 7, or 15 secondary channel respectively. The primary channel is a common channel operation for all STAs where management frames are sent by the AP to ensure that all STAs (regardless of channel bonding support) can receive.

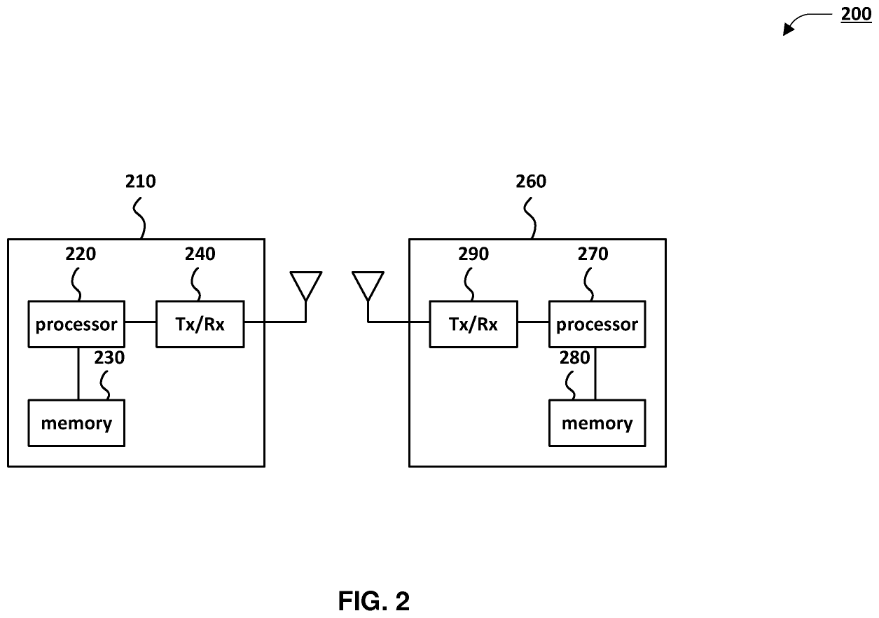

FIG. 2 is a block diagram illustrating example implementations of a STA 210 and an AP 260. As shown in FIG. 2, STA 210 may include at least one processor 220, a memory 230, and at least one transceiver 240. AP 260 may include at least one processor 270, a memory 280, and at least one transceiver 290. Processor 220/270 may be operatively connected to memory 230/280 and/or to transceiver 240/290.

Processor 220/270 may implement functions of the PHY layer, the MAC layer, and/or the logical link control (LLC) layer of the corresponding device (STA 210 or AP 260). Processor 220/270 may include one or more processors and/or one or more controllers. The one or more processors and/or one or more controllers may comprise, for example, a general-purpose processor, a digital signal processor (DSP), a microcontroller, an application specific integrated circuit (ASIC), a field programmable gate array (FPGA), a logic circuit, or a chipset, for example.

Memory 230/280 may include a read-only memory (ROM), a random-access memory (RAM), a flash memory, a memory card, a storage medium, and/or other storage unit. Memory 230/280 may comprise one or more non-transitory computer readable mediums. Memory 230/280 may store computer program instructions or code that may be executed by processor 220/270 to carry out one or more of the operations/embodiments discussed in the present application. Memory 230/280 may be implemented (or positioned) within processor 220/270 or external to processor 220/270. Memory 230/280 may be operatively connected to processor 220/270 via various means known in the art.

Transceiver 240/290 may be configured to transmit/receive radio signals. In some circumstances, transceiver 240/290 may implement a PHY layer of the corresponding device (STA 210 or AP 260). In some circumstances, STA 210 and/or AP 260 may be a multi-link device (MLD), that is a device capable of operating over multiple links as defined by the IEEE 802.11 standard. As such, STA 210 and/or AP 260 may each implement multiple PHY layers. The multiple PHY layers may be implemented using one or more of transceivers 240/290.

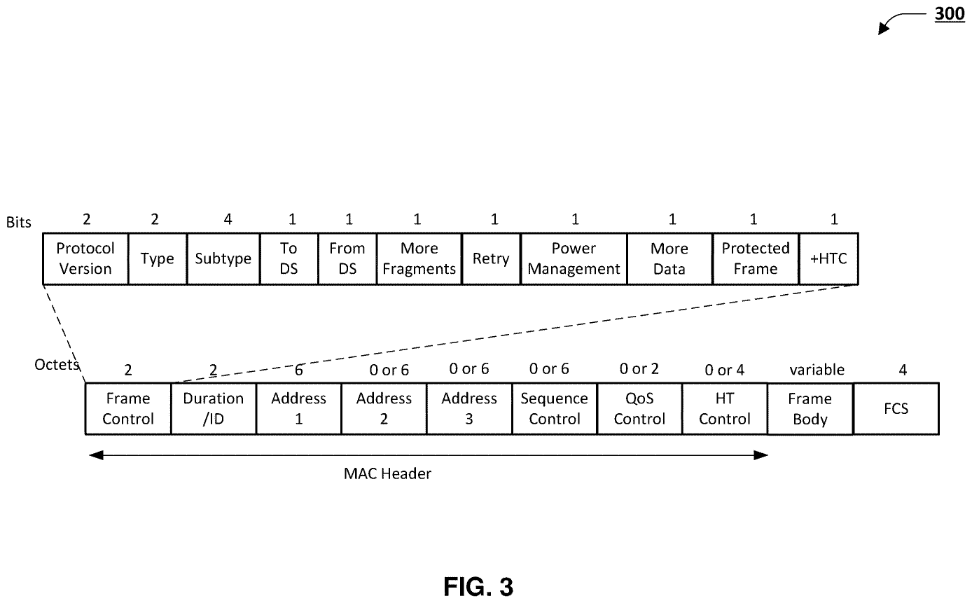

FIG. 3 illustrates an example format of a MAC frame. In operation, a STA may construct a subset of MAC frames for transmission and may decode a subset of received MAC frames upon validation. The particular subsets of frames that a STA may construct and/or decode may be determined by the functions supported by the STA. A STA may validate a received MAC frame using the frame check sequence (FCS) contained in the frame and may interpret certain fields from the MAC headers of all frames.

As shown in FIG. 3, a MAC frame includes a MAC header, a variable length frame body, and a frame check sequence (FCS).

The MAC header includes a frame control field, an optional duration/ID field, address fields, an optional sequence control field, an optional QoS control field, and an optional HT control field.

The frame control field includes the following subfields: protocol version, type, subtype, “To DS”, “From DS”, “More Fragments”, retry, power management, “More Data, protected frame, and +HTC.

The protocol version subfield is invariant in size and placement across all revisions of the IEEE 802.11 standard. The value of the protocol version subfield is 0 for MAC frames.

The type and subtype subfields together identify the function of the MAC frame. There are three frame types: control, data, and management. Each of the frame types has several defined subtypes. Bits within the subtype subfield are used to indicate a specific modification of the basic data frame (subtype 0). For example, in data frames, the most significant bit (MSB) of the subtype subfield, bit 7 (B7) of the frame control field, is defined as the QoS subfield. When the QoS subfield is set to 1, it indicates a QoS data frame, which is a data frame that contains a QoS control field in its MAC header. The second MSB of the subtype field, bit 6 (B6) of the frame control field, when set to 1 in data subtypes, indicates a data frame that contain no frame body field.

The “To DS” subfield indicates whether a data frame is destined to the distribution system (DS). The “From DS” subfield indicates whether a data frame originates from the DS.

The “More Fragments” subfield is set to 1 in all data or management frames that have another fragment to follow the MAC service data unit (MSDU) or MAC management protocol data unit (MMPDU) carried by the MAC frame. The “More Fragments” subfield is set to 0 in all other frames in which the “More Fragments” subfield is present.

The retry subfield is set to 1 in any data or management frame that is a retransmission of an earlier frame. It is set to 0 in all other frames in which the retry subfield is present. A receiving STA uses this indication to aid it in the process of eliminating duplicate frames. These rules do not apply for frames sent by a STA under a block agreement.

The power management subfield is used to indicate the power management mode of a STA.

The “More Data” subfield indicates to a STA in power save (PS) mode that bufferable units (BUs) are buffered for that STA at the AP. The “More Data” subfield is valid in individually addressed data or management frames transmitted by an AP to a STA in PS mode. The “More Data” subfield is set to 1 to indicate that at least one additional buffered BU is present for the STA.

The protected frame subfield is set to 1 if the frame body field contains information that has been processed by a cryptographic encapsulation algorithm.

The +HTC subfield indicates that the MAC frame contains an HT control field.

The duration/ID field of the MAC header indicates various contents depending on the frame type and subtype and the QoS capabilities of the sending STA. For example, in control frames of the power save poll (PS-Poll) subtype, the duration/ID field carries an association identifier (AID) of the STA that transmitted the frame in the 14 least significant bits (LSB), with the 2 most significant bits (MSB) set to 1. In other frames sent by STAs, the duration/ID field contains a duration value (in microseconds) which is used by a recipient to update a network allocation vector (NAV). The NAV is a counter that indicates to a STA an amount of time during which the STA must defer from accessing the shared medium.

Up to four address fields may be present in the MAC frame format. The address fields are used to indicate the basic service set identifier (BSSID), source address (SA), destination address (DA), transmitting address (TA), and receiving address (RA). Certain frames may not contain some of the address fields. Certain address field usage may be specified by the relative position of the address field (1-4) within the MAC header, independent of the type of address present in that field. Specifically, the address 1 field always identifies the intended receiver(s) of the frame, and the address 2 field, where present, always identifies the transmitter of the frame.

The sequence control field includes two subfields, a sequence number subfield and a fragment number subfield. The sequence number subfield in data frames indicates the sequence number of the MSDU (if not in an Aggregated MSDU (A-MSDU)) or A-MSDU. The sequence number subfield in management frames indicates the sequence number of the frame. The fragment number subfield indicates the number of each fragment of an MSDU or MMPDU. The fragment number is set to 0 in the first or only fragment of an MSDU or MMPDU and is incremented by one for each successive fragment of that MSDU or MMPDU. The fragment number is set to 0 in a MAC protocol data unit (MPDU) containing an A-MSDU, or in an MPDU containing an MSDU or MMPDU that is not fragmented. The fragment number remains constant in all retransmissions of the fragment.

The QoS control field identifies the traffic category (TC) or traffic stream (TS) to which the MAC frame belongs. The QoS control field may also indicate various other QoS related, A-MSDU related, and mesh-related information about the frame. This information can vary by frame type, frame subtype, and type of transmitting STA. The QoS control field is present in all data frames in which the QoS subfield of the subtype subfield is equal to 1.

The HT control field is present in QoS data, QoS null, and management frames as determined by the +HTC subfield of the frame control field.

The frame body field is a variable length field that contains information specific to individual frame types and subtypes. The frame body may include one or more MSDUs or MMPDUs. The minimum length of the frame body is 0 octets.

The FCS field contains a 32-bit Cyclic Redundancy Check (CRC) code. The FCS field value is calculated over all of the fields of the MAC header and the frame body field.

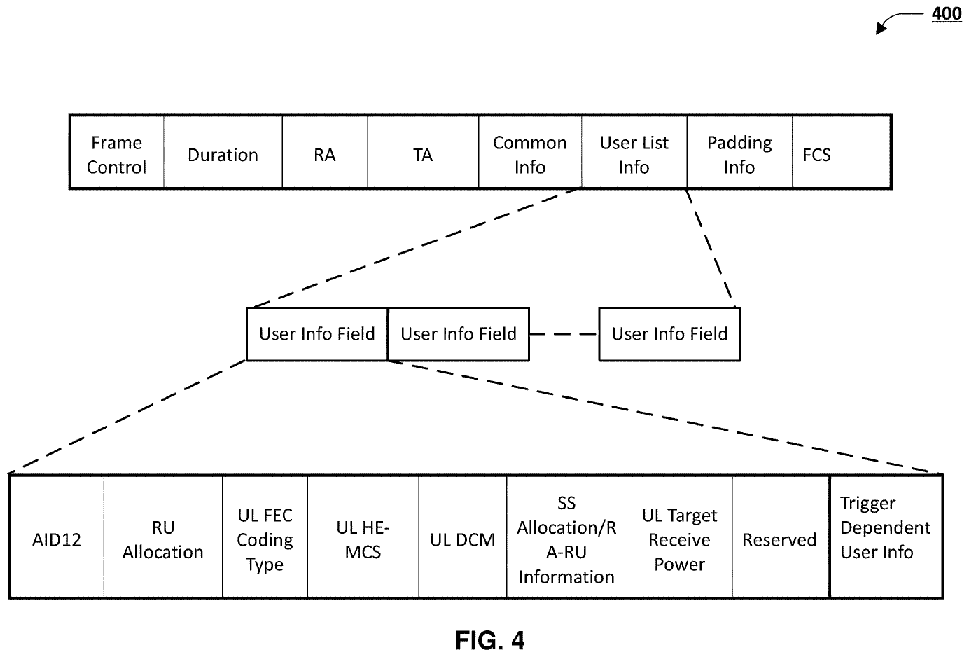

FIG. 4 illustrates an example trigger frame 400. Trigger frame 400 may correspond to a basic trigger frame as defined in the existing IEEE 802.11ax standard amendment. Trigger frame 400 may be used by an AP to allocate resources for and solicit one or more TB PPDU transmissions from one or more STAs. Trigger frame 400 may also carry other information required by a responding STA to transmit a TB PPDU to the AP.

As shown in FIG. 4, trigger frame 400 includes a Frame Control field, a Duration field, a receiver address (RA) field, a transmitter address (TA) field, a Common Info field, a User List Info field, a Padding field, and an FCS field.

The Frame Control field includes the following subfields: protocol version, type, subtype, To DS, From DS, more fragments, retry, power management, more data, protected frame, and +HTC.

The Duration field indicates various contents depending on frame type and subtype and the QoS capabilities of the sending STA. For example, in control frames of the power save poll (PS-Poll) subtype, the Duration field carries an association identifier (AID) of the STA that transmitted the frame in the 14 least significant bits (LSB), and the 2 most significant bits (MSB) are both set to 1. In other frames sent by STAs, the Duration field contains a duration value (in microseconds) which is used by a recipient to update a network allocation vector (NAV).

The RA field is the address of the STA that is intended to receive the incoming transmission from the transmitting station. The TA field is the address of the STA transmitting trigger frame 400 if trigger frame 400 is addressed to STAs that belong to a single BSS. The TA field is the transmitted BSSID if the trigger frame 400 is addressed to STAs from at least two different BSSs of the multiple BSSID set.

The common info field may have a format as illustrated by common info field 600 described further below. The common info field specifies a trigger frame type of trigger frame 400, a transmit power of trigger frame 400 in dBm, and several key parameters of a TB PPDU that is transmitted by a STA in response to trigger frame 400. The trigger frame type of a trigger frame used by an AP to receive QoS data using UL MU operation is referred to as a basic trigger frame.

The User List Info field contains a User Info field per STA addressed in trigger frame 400. The per STA User Info field includes, among others, an AID subfield, an RU Allocation subfield, a Spatial Stream (SS) Allocation subfield, an MCS subfield to be used by a STA in a TB PPDU transmitted in response to trigger frame 400, and a Trigger Dependent User Info subfield. The Trigger Dependent User Info subfield can be used by an AP to specify a preferred access category (AC) per STA. The preferred AC sets the minimum priority AC traffic that can be sent by a participating STA. The AP determines the list of participating STAs, along with the BW, MCS, RU allocation, SS allocation, Tx power, preferred AC, and maximum duration of the TB PPDU per participating STA.

The Padding field is optionally present in trigger frame 400 to extend the frame length to give recipient STAs enough time to prepare a response for transmission one SIFS (short interframe spacing) after the frame is received. The Padding field, if present, is at least two octets in length and is set to all 1s.

The FCS field is used by a STA to validate a received frame and to interpret certain fields from the MAC headers of a frame.

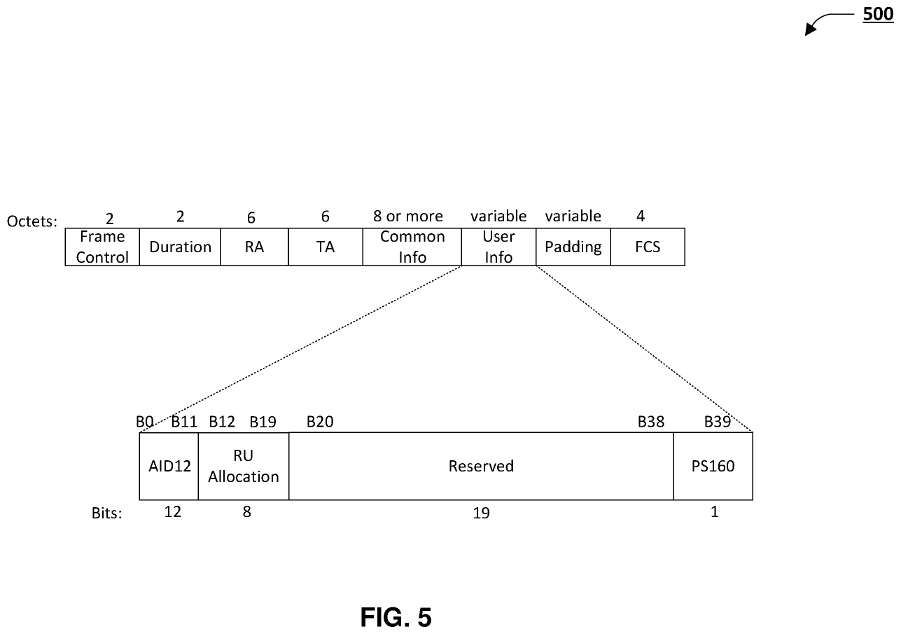

FIG. 5 illustrates an example multi-user request to send (MU-RTS) trigger frame 500. MU-RTS trigger frame 500 may be used by an AP to solicit simultaneous CTS frames from multiple STAs to transmit a downlink (DL) MU PPDU to the multiple STAs. As shown in FIG. 5, MU-RTS trigger frame 500 may comprise a frame control field, a duration field, an RA field, a TA field, a common info field, one or more user info fields, a padding field, and an FCS field. The frame control, TA, RA, padding, and FCS fields may be similar to the corresponding fields of trigger frame 400 described above. The common info field may have a format as illustrated by common info field 600 described further below. The duration field may be set to the time, in microseconds, required to transmit the DL MU PPDU, plus the time required to transmit one CTS frame, one ACK frame (if required), and three SIFS periods.

The one or more user info fields correspond respectively to the one or more STAs solicited by MU-RTS trigger frame 500. As shown in FIG. 5, a user info field may comprise an AID12 subfield, an RU allocation subfield, reserved bits, and a PS 160 subfield. The AID 12 subfield comprises an association identifier of the STA to which the user info field is addressed. The RU allocation subfield indicates a channel on which the solicited STA is to transmit the CTS frame. In an example, this may include a primary 20 MHz channel, a primary 40 MHz, a primary 80 MHz channel, a primary 160 MHz, an 80+80 MHz channel, or a 320 MHz channel.

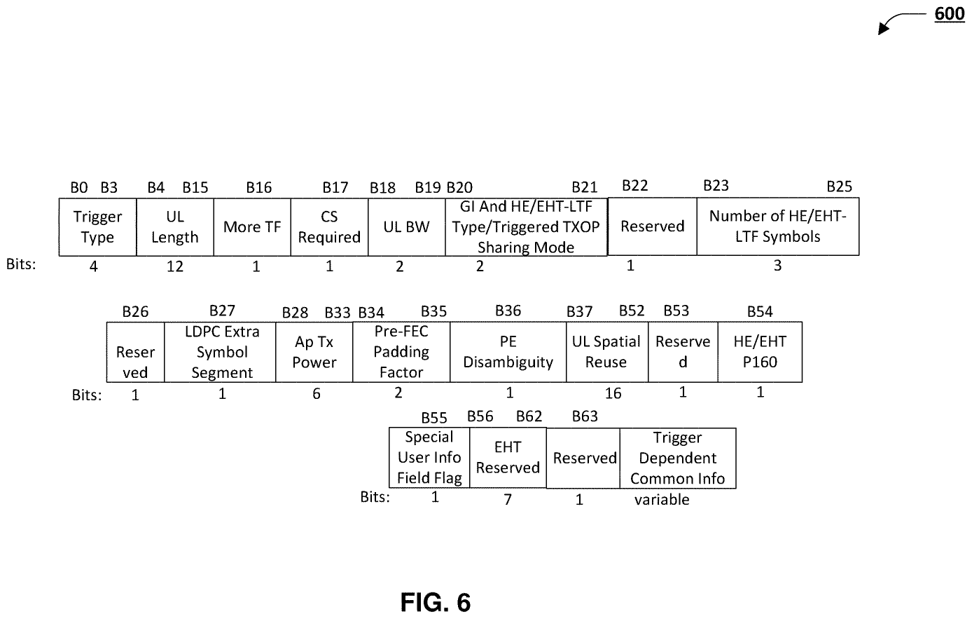

FIG. 6 illustrates an example Common Info field 600. Common Info field 600 may be an example implementation of the Common Info field of trigger frame 400 or MU-RTS trigger frame 500, for example. As shown in FIG. 6, Common Info field 600 may include a Trigger Type subfield, a UL Length subfield, a More TF subfield, a CS required subfield, a UL BW subfield, a GI and HE/EHT-LTF Type/Triggered TXS Mode subfield, a first Reserved subfield, a Number of HE/EHT-LTF Symbols subfield, a second Reserved subfield, an LDPC Extra Symbol Segment subfield, an AP Tx Power subfield, a Pre-FEC Padding Factor subfield, a PE Disambiguity subfield, an UL Spatial Reuse subfield, a third Reserved subfield, an HE/EHT P160 subfield, a Special User Info Field Flag subfield, an EHT Reserved subfield, a fourth Reserved subfield, and a Trigger Dependent Common Info subfield. The Trigger Type subfield, UL Length subfield, More TF subfield, CS required subfield, UL BW subfield, GI and HE-LTF Type/Triggered TXS Mode subfield, first Reserved subfield, Number of HE/EHT-LTF Symbols subfield, second Reserved subfield, LDPC Extra Symbol Segment subfield, AP Tx Power subfield, Pre-FEC Padding Factor subfield, PE Disambiguity subfield, UL Spatial Reuse subfield, third Reserved subfield, HE/EHT P160 subfield, Special User Info Field Flag subfield, EHT Reserved subfield, fourth Reserved subfield, and Trigger Dependent Common Info subfield may have the same content and interpretation as corresponding subfields of an EHT variant Common Info field defined in the IEEE 802.11be draft amendment (“IEEE P802.11be/D3.1, March 2023”).

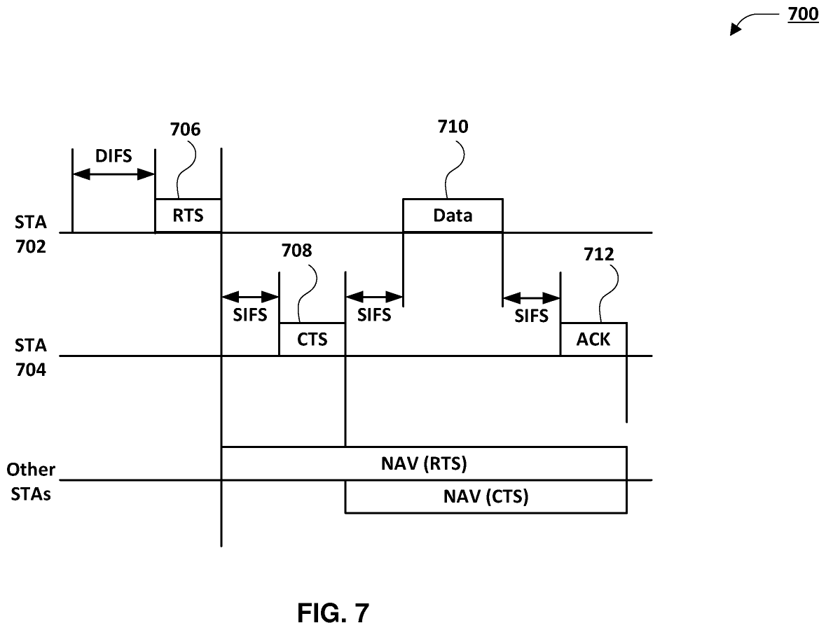

FIG. 7 illustrates an example 700 of a Request-to-Send (RTS)/Clear-to-Send (CTS) procedure. Example 700 may be an example according to the RTS/CTS procedure as defined in section 10.3.2.9 of the IEEE 802.11 standard draft “IEEE P802.11-REVme™/D3.0, April 2023.” As shown in FIG. 7, example 700 may include STAs 702 and 704. Other STAs of the same BSS may also be within communication range of STAs 702 and 704.

In an example, STA 702 may transmit an RTS frame 706 to STA 704. STA 702 may transmit RTS frame 706 to protect from hidden STA(s) the transmission of a data frame 710 that STA 702 intends to transmit. RTS frame 706 may include a Duration/ID field. The Duration/ID field may be set to the time, in microseconds, required to transmit data frame 710, plus one CTS frame, plus one ACK frame (if required), plus three SIFS (Short Interframe Spacing) periods.

In an example, STA 704 may respond to RTS frame 706 by transmitting a CTS frame 708 to STA 702. CTS frame 708 may be transmitted one SIFS period after RTS frame 706. STA 704 may respond to RTS frame 706 when RTS frame 706 is addressed to STA 704 and after considering the NAV, unless the NAV was set by a frame originating from STA 702. STA 704 may respond to the RTS frame 706 when RTS frame 706 is addressed to STA 704 and if the NAV indicates idle. For a non-S1G STA, the NAV indicates idle when the NAV count is 0 or when the NAV count is non-zero but a nonbandwidth signaling TA obtained from a TA field of RTS frame 706 matches a saved TXOP holder address. For an S1G STA, the NAV indicates idle when both the NAV and RID (response indication deferral) counters are 0 or when either the NAV or RID counter is non-zero but the TA field of RTS frame 706 matches the saved TXOP holder address.

STA 704 may set an RA field of CTS frame 708 to a nonbandwidth signaling TA obtained from the TA field of RTS frame 706. STA 704 may set a Duration field of CTS frame 708 based on the Duration/ID field of RTS frame 706, namely as equal to the value of the Duration/ID field of RTS frame 706, adjusted by subtracting the time required to transmit CTS frame 708 and one SIFS period.

Upon receiving CTS frame 708, STA 702 may wait one SIFS period before transmitting data frame 710. STA 704 may transmit an ACK frame 712 in response to data frame 710. STA 704 may transmit ACK frame 712 one SIFS after receiving data frame 710.

For example, a STA receiving RTS frame 706 may set its NAV based on the Duration/ID field of RTS frame 706. Another STA receiving CTS frame 708 may set its NAV based on the Duration field of CTS frame 708. As such, the other STAs may not access the channel using EDCA until the end of transmission of ACK frame 712.

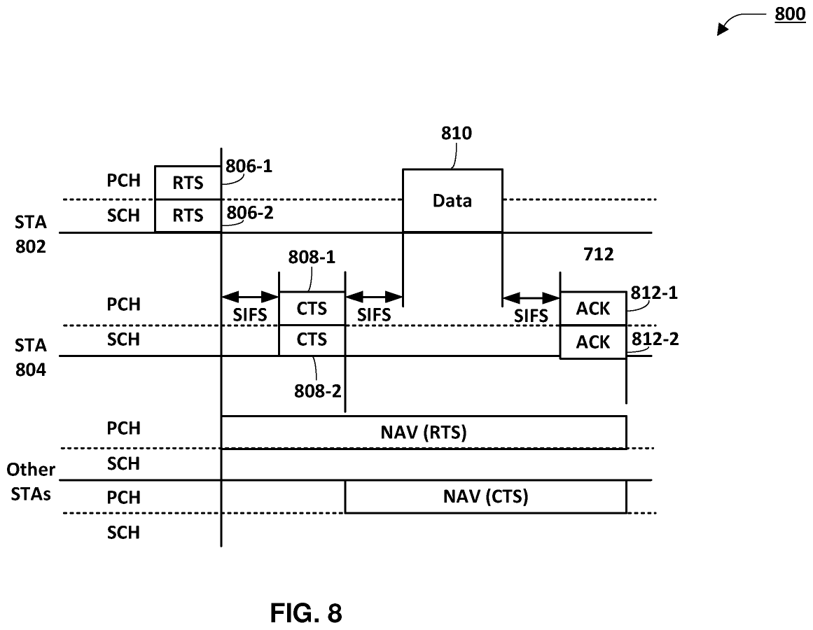

FIG. 8 illustrates an example 800 of a wideband RTS/CTS procedure. As shown in FIG. 8, example 800 may include STAs 802 and 804. Other STAs may also be within communication range of STAs 802 and 804. STAs 802 and 804 may each operate on a primary channel (PCH) and a secondary channel (SCH). For example, without limitation, the PCH may correspond to a primary 20 MHz channel and the SCH may correspond to a secondary 20 MHz channel.

Example 800 may begin with STA 802 accessing both the PCH and SCH to transmit simultaneously RTS frames 806-1 and 806-2 on the PCH and the SCH, respectively, to STA 804. In an example, RTS frames 806-1 and 806-2 may be transmitted in a non-HT duplicate PPDU having a bandwidth equal to the combined bandwidth of the PCH and the SCH (e.g., 40 MHz). In an implementation, before transmitting RTS frames 806-1 and 806-2, STA 802 may check a NAV associated with the PCH. If the NAV associated with the PCH indicates that the PCH is idle, STA 802 may perform a clear channel assessment (CCA) on the PCH and the SCH. The CCA may include determining whether a received signal energy on a channel exceeds an energy detect (ED) threshold. The CCA returns a “channel busy” condition when the received signal energy on the channel exceeds the ED threshold and a “channel idle” condition when the received signal energy on the channel is below the ED threshold. If the CCA indicates “channel idle” on both the PCH and the SCH, STA 802 may access both the PCH and the SCH to transmit RTS frames 806-1 and 806-2.

RTS frames 806-1 and 806-2 may be duplicate frames. RTS frames 806-1 and 806-2 may include a duration field indicating the time, in microseconds, required to transmit a data frame 810, plus one CTS frame, plus one Ack frame, plus three SIFSs.

On receiving RTS frames 806-1 and 806-2, other STAs within the communication range of STA 802 may set a NAV associated with the PCH based on RTS frame 806-1. In an implementation, the other STAs may not maintain a NAV for the SCH.

On receiving RTS frames 806-1 and 806-2, STA 804 responds to STA 802 by transmitting CTS frames 808-1 and 808-2 on the PCH and the SCH respectively. CTS frames 808-1 and 808-2 may be transmitted a SIFS after STA 804 receives RTS frames 806-1 and 806-2 respectively. In an implementation, STA 804 transmits CTS frames 808-1 and 808-2 on the PCH and the SCH respectively based on a NAV associated with the PCH indicating that the PCH is idle. In an implementation, STA 804 may not maintain a NAV for the SCH or may not check a NAV associated with the SCH before transmitting CTS frames 808-1 and 808-2.

On receiving CTS frames 808-1 and 808-2, other STAs within the communication range of STA 804 may set a NAV associated with the PCH based on CTS frame 808-1. In an implementation, the other STAs may not maintain a NAV for the SCH.

On receiving CTS frames 808-1 and 808-2, STA 802 may proceed to transmit data frame 810 on both the PCH and the SCH. Data frame 810 may be transmitted a SIFS after STA 802 receives CTS frames 808-1 and 808-2. In an implementation, STA 802 may proceed to transmit data frame 810 on both the PCH and the SCH on the sole condition of receiving CTS frame 808-1 on the PCH. That is, STA 802 may not be required to receive CTS frame 808-2 on the SCH to transmit data frame 810 on the SCH as well as the PCH.

In an implementation, STA 804 may acknowledge data frame 810 by transmitting ACK frames 812-1 and 812-2 on the PCH and the SCH, respectively. ACK frames 812-1 and 812-2 may be transmitted a SIFS after STA 804 receives data frame 810.

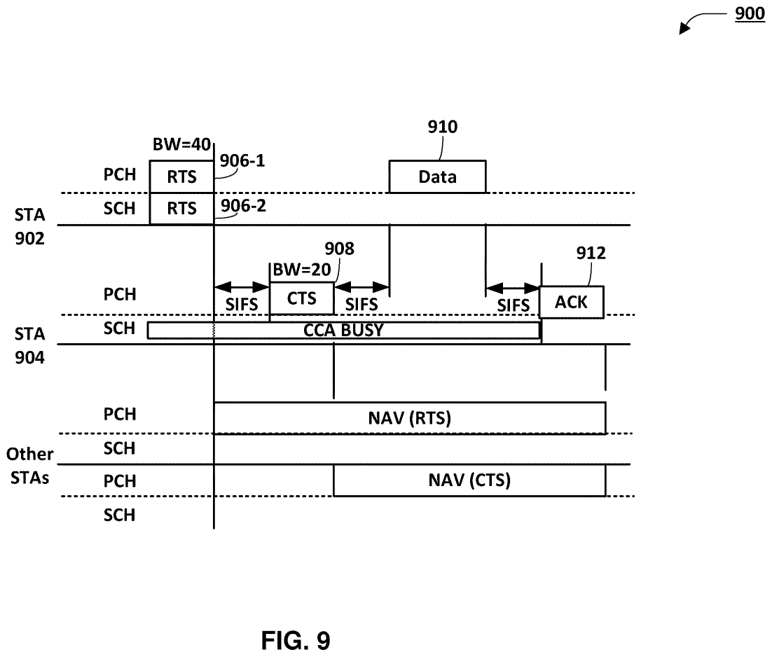

FIG. 9 illustrates an example 900 of a wideband RTS/CTS procedure that uses a bandwidth signaling RTS frame. As shown in FIG. 9, example 900 may include STAs 902 and 904. Other STAs may also be within communication range of STAs 902 and 904. STAs 902 and 904 may each operate on a primary channel (PCH) and a secondary channel (SCH). For example, without limitation, the PCH may correspond to a primary 20 MHz channel and the SCH may correspond to a secondary 20 MHz channel.

Example 900 may begin with STA 902 accessing both the PCH and SCH to transmit simultaneously RTS frames 906-1 and 906-2 on the PCH and the SCH, respectively, to STA 904. In an example, RTS frames 906-1 and 906-2 may be transmitted in a non-HT duplicate PPDU having a bandwidth equal to the combined bandwidth of the PCH and the SCH (e.g., 40 MHz). In an implementation, before transmitting RTS frames 906-1 and 906-2, STA 902 may check a NAV associated with the PCH. If the NAV associated with the PCH indicates that the PCH is idle, STA 902 may perform a CCA on the PCH and the SCH. The CCA may include determining whether a received signal energy on a channel exceeds an ED threshold. The CCA returns a “channel busy” condition when the received signal energy on the channel exceeds the ED threshold and a “channel idle” condition when the received signal energy on the channel is below the ED threshold. If the CCA indicates “channel idle” on both the PCH and the SCH, STA 902 may access both the PCH and the SCH to transmit RTS frames 906-1 and 906-2.

RTS frames 906-1 and 906-2 may be duplicate frames. RTS frames 906-1 and 906-2 may include a duration field indicating the time, in microseconds, required to transmit a data frame 910, plus one CTS frame, plus one Ack frame, plus three SIFSs.

In example 900, RTS frames 906-1 and 906-2 may be bandwidth signaling RTS frames. That is, RTS frames 906-1 and 906-2 may each include a field that indicates the bandwidth of the PPDU (e.g., 40 MHz) carrying RTS frames 906-1 and 906-2.

On receiving RTS frames 906-1 and 906-2, other STAs within the communication range of STA 902 may set a NAV associated with the PCH based on RTS frame 906-1. In an implementation, the other STAs may not maintain a NAV for the SCH.

On receiving RTS frames 906-1 and 906-2, STA 904 may decode the field indicating the bandwidth of the PPDU carrying RTS frames 906-1 and 906-2. The PPDU bandwidth may indicate to STA 904 that STA 902 wishes that STA 904 respond with CTS frames on both the PCH and the SCH. In an implementation, before responding to RTS frames 906-1 and 906-2, STA 904 may check a NAV associated with the PCH. In an implementation, STA 904 may not maintain a NAV for the SCH or may not check a NAV associated with the SCH before responding to RTS frames 906-1 and 906-2. In an implementation, if the NAV associated with the PCH indicates that the PCH is idle, STA 904 may perform a CCA on the PCH and the SCH. In an implementation, STA 904 may respond on both the PCH and the SCH if the CCA indicates “channel idle” on both the PCH and the SCH. In an implementation, STA 904 may respond on the PCH only if the CCA indicates “channel idle” on the PCH and “channel busy” on the SCH. In an implementation, STA 904 may not respond on the PCH or the SCH if the NAV associated with the PCH is non-zero.

In example 900, the CCA returns “channel idle” on the PCH and “channel busy” on the SCH. As such, STA 904 may transmit a CTS frame 908 only on the PCH. CTS frame 908 may thus have a bandwidth that is narrower than the PPDU bandwidth indicated in RTS frames 906-1 and 906-2. CTS frame 908 may be transmitted a SIFS after STA 904 receives RTS frames 906-1 and 906-2 respectively.

On receiving CTS frame 908, other STAs within the communication range of STA 904 may set a NAV associated with the PCH based on CTS frame 908.

On receiving CTS frame 908, STA 902 may proceed to transmit data frame 910 on the PCH. Data frame 910 may be transmitted a SIFS after STA 902 receives CTS frame 908. In an implementation, STA 904 may acknowledge data frame 910 by transmitting an ACK frame 912 on the PCH. ACK frame 912 may be transmitted a SIFS after STA 904 receives data frame 910.

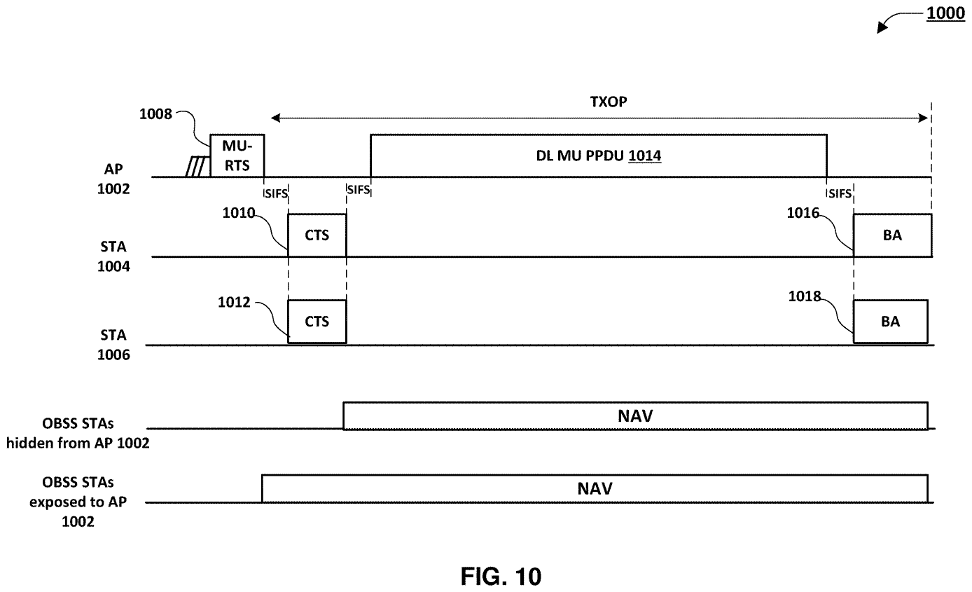

FIG. 10 is an example 1000 that illustrates a multi-user Request-to-Send (MU-RTS)/Clear-to-Send (CTS) procedure. Example 1000 may be an example according to the MU-RTS/CTS procedure as defined in section 26.2.6 of the IEEE 802.11 standard draft (“IEEE P802.11-REVme™/D3.0, April 2023”). As shown in FIG. 10, example 1000 may include an AP 1002 and STAs 1004 and 1006. STAs 1004 and 1006 may be associated with AP 1002. For the purpose of illustration, example 1000 also illustrates STAs of an overlapping basic service set (OBSS) relative to the BSS of AP 1002 (OBSS STAs). The OBSS STAs, as shown in FIG. 10, may be hidden from AP 1002 (outside of the communication range of AP 1002) or exposed to AP 1002 (within the communication range of AP 1002).

In example 1000, AP 1002 wishes to transmit a downlink (DL) multi-user (MU) PPDU 1014 to STAs 1004 and 1006. DL MU PPDU 1014 may comprise data for each of STAs 1004 and 1006. DL MU PPDU 1014 may occupy a plurality of channels (e.g., 20 MHz channels). Each channel of the plurality of channels may carry the data for a respective STA (e.g., STA 1004, STA 1006) served by DL MU PPDU 1014.

As shown in FIG. 10, to protect the transmission of DL MU PPDU 1014 to STAs 1004 and 1006 from interference by OBSS STAs hidden from AP 1002, AP 1002 may use the MU-RTS/CTS procedure to initiate a TXOP and to protect the TXOP frame exchange sequence. AP 1002 may initiate the TXOP by transmitting an MU-RTS trigger frame 1008 that solicits simultaneous CTS frame transmissions from STAs 1004 and 1006.

MU-RTS trigger frame 1008 may have a format as illustrated by MU-RTS trigger frame 500 illustrated in FIG. 5. As such, MU-RTS trigger frame 1008 may comprise a frame control field, a duration field, an RA field, a TA field, a common info field, one or more user info fields, a padding field, and an FCS field. The duration field may be set to the time, in microseconds, required to transmit DL MU PPDU 1014, plus the time required to transmit one CTS frame, one ACK frame (if required), and three SIFS periods.

The one or more user info fields correspond respectively to the one or more STAs solicited by the MU-RTS trigger frame. In example 1000, MU-RTS trigger frame 1008 may comprise a user info field for each of STAs 1004 and 1006 indicating that a CTS frame is solicited from each of STAs 1004 and 1006. As shown in FIG. 8, a user info field may comprise an AID12 subfield, an RU allocation subfield, reserved bits, and a PS 160 subfield. The AID12 subfield comprises an association identifier of the STA to which the user info field is addressed. The RU allocation subfield indicates a channel on which the solicited STA is to transmit the CTS frame. In an example, this may include a primary 20 MHz channel, a primary 40 MHz, a primary 80 MHz channel, a primary 160 MHz, an 80+80 MHz channel, or a 320 MHz channel.

AP 1002 may send MU-RTS trigger frame 1008 in a PPDU that occupies one or more channels (e.g., 20 MHz channels). In an example, for each channel occupied by the PPDU that carries MU-RTS trigger frame 1008, AP 1002 may request at least one non-AP STA to send a CTS frame that occupies that channel. In an example, AP 1002 may not request that a non-AP STA send a CTS frame that occupies a channel that is not occupied by the PPDU carrying MU-RTS trigger frame 1008.

After transmitting MU-RTS trigger frame 1008, AP 1002 may wait for a CTSTimeout interval of aSIFSTime+aSlotTime+aRxPHYStartDelay that begins when a MAC layer of AP 1002 receives a PHYTXEND. confirm primitive for transmitted MU-RTS trigger frame 1008. In an implementation, the aSIFSTime may comprise a nominal time (in microseconds) that the MAC and PHY require from reception of the end of a PPDU[+SigExt] on the wireless medium, until the MAC and PHY have processed any frame(s) therein, and responded with the start on the WM of the PPDU containing the earliest possible response frame. In an implementation, the aSlotTime may comprise a duration of a backoff slot used by a STA when accessing the wireless medium. In an implementation, the aRxPHYStartDelay may comprise a duration from the start of the PPDU at the antenna of the receiver, to the issuance of earlier of the PHYRXEARLYSIG.indication if sent or the PHY-RXSTART.indication primitive. If the MAC layer does not receive a PHY-RXEARLYSIG.indication or a PHY-RXSTART.indication primitive during the CTSTimeout interval, AP 1002 may conclude that the transmission of MU-RTS trigger frame 1008 has failed, and, if MU-RTS trigger frame 1008 initiated a TXOP, AP 1002 may invoke its backoff procedure. If the MAC layer receives a PHY-RXEARLYSIG.indication or a PHY-RXSTART.indication primitive during the CTSTimeout interval, then the MAC layer may wait for the corresponding PHY-RXEND.indication primitive to determine whether transmission of MU-RTS trigger frame 1008 was successful. The receipt of a CTS frame from any non-AP STA addressed by MU-RTS trigger frame 1008 before the PHY-RXEND. indication primitive shall be interpreted as the successful transmission of MU-RTS trigger frame 1008, permitting the frame exchange sequence to continue. The receipt of any other type of frame shall be interpreted as a failure of the transmission of MU-RTS trigger frame 1008. AP 1002 may process the received frame and, if MU-RTS trigger frame 1008 initiated a TXOP, AP 1002 shall invoke its backoff procedure at the PHY-RXEND.indication primitive.

In example 1000, on receiving MU-RTS trigger frame 1008, STAs 1004 and 1006 respond by transmitting respectively CTS frames 1010 and 1012 to AP 1002. In an example, STAs 1004 and 1006 begin the transmission of CTS frames 1010 and 1012, respectively, at the SIFS time boundary after an end of a received PPDU comprising MU-RTS trigger frame 1008. In an example, STA 1004 (or STA 1006) responds to MU-RTS trigger frame 1008 with a CTS frame when the following conditions are met: MU-RTS trigger frame 1008 comprises a user info field addressed to the STA (the AID12 subfield of the user info field is equal to the 12 LSBs of the AID of the STA) and MU-RTS trigger frame 1008 is sent by an AP with which the STA is associated; and the UL MU CS condition indicates that the medium is idle as described in section 26.5.2.5 (UL MU CS mechanism) of the IEEE 802.11 standard (“IEEE P802.11-REVme™/D3.0, April 2023”). Otherwise, if one of the conditions is not met, STA 1004 (or STA 1006) does not send a CTS frame to AP 1002.

In an example, STAs 1004 and 1006 may set an RA field of respectively CTS frames 1010 and 1012 to a TA obtained from the TA field of MU-RTS trigger frame 1008. In an example, STAs 1004 and 1006 may set a duration field of respectively CTS frames 1010 and 1012 based on the duration field of MU-RTS trigger frame 1008, namely as equal to the value of the duration field of MU-RTS trigger frame 1008, adjusted by subtracting the time required to transmit respectively CTS frames 1010 and 1012 and one SIFS period.

OBSS STAs exposed to AP 1002 may receive MU-RTS trigger frame 1008 due to being within the communication range of AP 1002. In an example, as shown in FIG. 10, on receiving MU-RTS trigger frame 1008, OBSS STAs exposed to AP 1002 set their respective NAVs based on the duration field of MU-RTS trigger frame 1008. As such, the OBSS STAs exposed to AP 1002 may not access the wireless medium for the duration of the TXOP initiated by AP 1002.

OBSS STAs hidden from AP 1002 do not receive MU-RTS trigger frame 1008 due to being outside the communication range of AP 1002. However, in an example, as shown in FIG. 10, some of the OBSS STAs hidden from AP 1002 may receive CTS frame 1010 and/or CTS frame 1012 and may set their respective NAVs based on the duration field of CTS frame 1010 and/or CTS frame 1012. As such, some of the OBSS STAs hidden from AP 1002 may also not access the wireless medium for the duration of the TXOP initiated by AP 1002.

On receiving CTS frame 1010 and/or CTS frame 1012, AP 1002 may wait one SIFS period before transmitting DL MU PPDU 1014. On receiving DL MU PPDU 1014, STAs 1004 and 1006 may respond by transmitting respective Block Acknowledgement (BA) frames 1016 and 1018 to AP 1002.

It is envisioned in future IEEE 802.11 standards that a STA (AP STA or non-AP STA) may operate with multiple primary channels (e.g., may access a non-primary channel to communicate with another STA). Such operation may be referred to as non-primary channel access (NCPA) operation, and such a STA may be referred to as a multiple primary channel STA (MPC STA) or an NPCA STA. Specifically, in addition to a default primary channel (which is used by all STAs in the BSS and via which the AP transmits management frames), an MPC/NPCA STA may have a channel considered as an NPCA primary channel. The NCPA primary channel may be a secondary channel of the BSS. Hereinafter, the default primary channel is referred to as “primary channel” and secondary channel(s) considered as primary channel(s) are referred to as an NPCA primary channel or anchor channel(s) (or auxiliary primary channel(s)). The MPC/NPCA STA may transmit or receive on a channel that includes an NPCA primary channel but that does not necessarily include the primary channel (e.g., when the primary channel is unavailable). An MPC/NPCA STA may maintain a NAV for an NPCA primary channel or anchor channel independent of the NAV associated with the primary channel. A STA (AP STA or non-AP STA) that supports NPCA operation may be called an NPCA STA. An AP (AP STA) that supports NPCA operation may be called an NPCA AP. A non-AP STA that supports NPCA operation may be called a non-AP NPCA STA.

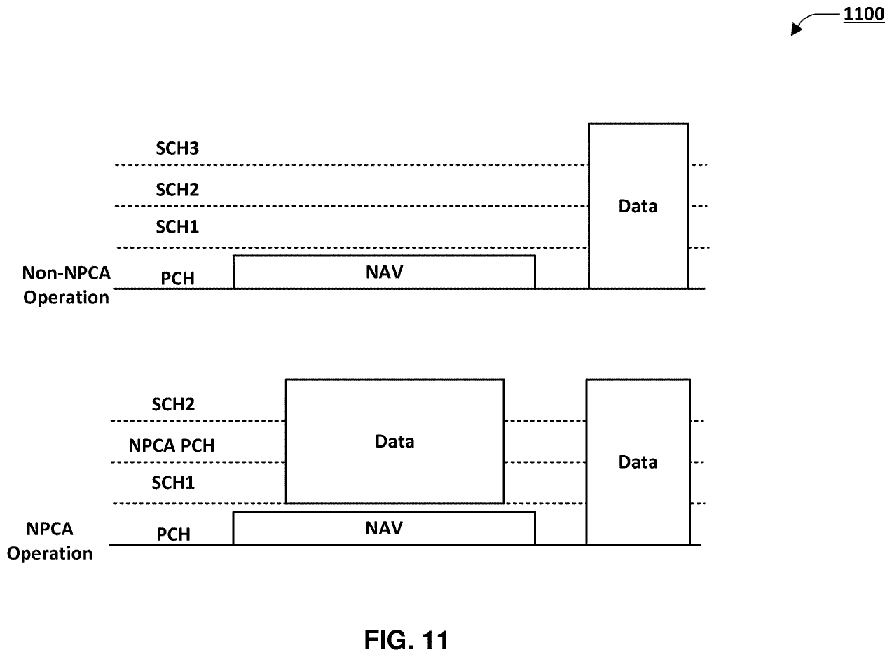

FIG. 11 is an example 1100 that illustrates MPC/NPCA operation. For the purpose of illustration, MPC/NPCA operation is contrasted with single primary channel (non-MPC/non-NPCA) operation. As shown in FIG. 11, a non-MPC/non-NPCA STA may be capable of operating over a plurality of channels, including a primary channel (PCH), a first secondary channel (SCH1), a second secondary channel (SCH2), and a third secondary channel (SCH2). According to NPCA operation, the same channels may include a primary channel (PCH), a first secondary channel (SCH1), an NPCA primary channel (NPCA PCH), and a second secondary channel (SCH2). It is noted that the position of the NPCA primary channel may or may not be as shown in the example of FIG. 11. For example, the NPCA primary channel may correspond to SCH1. In an example, the channel corresponding to the second secondary channel (SCH2) of the non-MPC/non-NPCA STA may correspond to an anchor channel (ACH) or NPCA PCH of the MPC/NPCA STA, and the channel corresponding to the third secondary channel (SCH3) of the non-MPC/non-NPCA STA may correspond to a second secondary channel (SCH2) of the MPC/NPCA STA. The primary channel (PCH) and the first secondary channel (SCH1) of the non-MPC/non-NPCA STA and the MPC/NPCA STA correspond to the same channels.

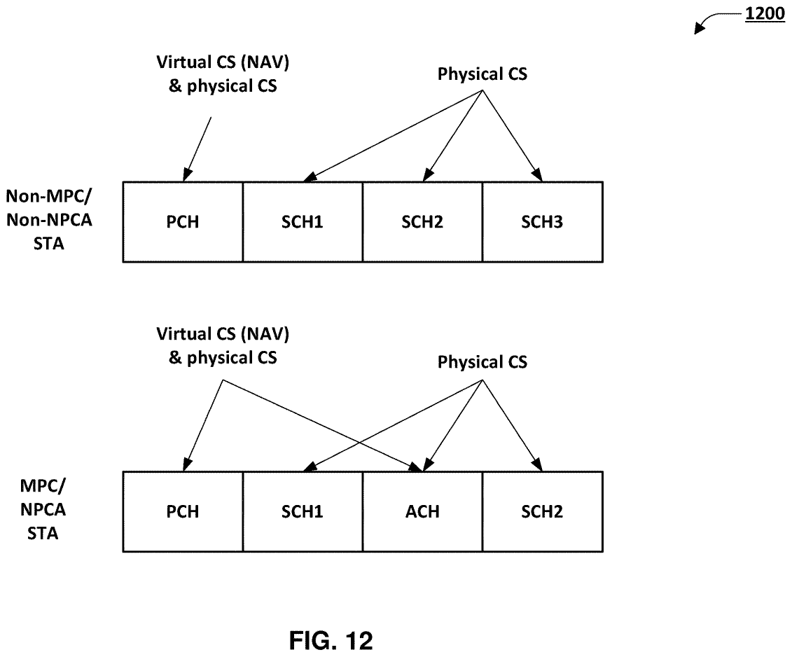

As shown in FIG. 11, in non-NPCA operation, when the STA has a non-zero NAV for the PCH, the STA may not communicate via any channel of the BSS. The non-zero NAV for the PCH may be due to the STA receiving/detecting an inter-BSS PPDU on the PCH. Instead, the STA waits for the NAV for the PCH to reach zero before contending for the PCH to transmit via the PCH. In an implementation, as shown in FIG. 12, in non-MPC/non-NPCA STA operation, a virtual carrier sense (CS) function (e.g., NAV) may be associated with only the PCH. Secondary channels may have only a physical CS function (e.g., energy detection) associated with them, which may be performed only when contending for transmission on the PCH. As such, as shown in FIG. 11, a non-MPC/non-NPCA STA may only transmit on a channel that includes the PCH (e.g., PCH, PCH+SCH1, PCH+SCH1+SCH2, PCH+SCH1+SCH2+SCH3) and only when the NAV associated with the PCH is zero (and the physical CS function indicates “channel idle” for all channels being used).

In NPCA operation, the STA may switch to the NPCA PCH when the STA detects/receives an inter-BSS PPDU on the PCH. The STA may set a NAV for the PCH based on the inter-BSS PPDU (e.g., based on a duration field a frame carried in the inter-BSS PPDU, a transmission opportunity (TXOP) duration field of the inter-BSS PPDU, or a length field of the inter-BSS PPDU) and may switch to the NPCA PCH for a duration based on the NAV set for the PCH. After switching to the NPCA PCH, the STA may communicate via the NPCA PCH or a channel comprising the NPCA PCH. In an implementation, as shown in FIG. 12, in MPC/NPCA STA operation, a virtual CS function (e.g., NAV) may be associated with multiple channels (e.g., PCH and NPCA PCH). As such, as shown in FIG. 11, an MPC/NPCA STA may transmit on channels that do not include the PCH but that include the NPCA PCH (e.g., NPCA PCH, NPCA PCH+SCH1, NPCA PCH+SCH2) if the NAV associated with the NPCA PCH is zero (and the physical CS indicates “channel idle” for all channels being used). In an implementation, an MPC/NPCA STA may also transmit on channels that do not include the PCH but that include the NPCA PCH (e.g., NPCA PCH, NPCA PCH+SCH1, NPCA PCH+SCH2) if the MPC/NPCA STA detects that the NPCA PCH is idle using physical CS for at least a medium synchronization duration.

In implementations, an MPC/NPCA STA may perform physical and/or virtual CS functions (herein referred to as CS or CCA) on multiple channels (e.g., PCH and NPCA PCH). If the PCH is busy (non-zero NAV or CCA indicates “channel busy”), the MPC/NPCA STA may use the NPCA PCH for transmission if the NPCA PCH is idle (zero NAV and CCA indicates “channel idle”).

In an implementation, an MPC/NPCA STA may support performing CS in parallel on multiple channels, including the PCH and the NPCA PCH. Such an NPCA STA may be referred to herein as a concurrent CCA MPC STA (such a STA may also be referred to as a concurrent CCA non-primary channel access (NPCA) STA or a Type 1 STA). Because of its concurrent CCA capability, a concurrent CCA MPC/NPCA STA is capable of medium synchronization simultaneously on multiple channels (e.g., PCH and NPCA PCH). Medium synchronization on a channel (e.g., PCH or NPCA PCH) may be performed by detecting a frame that includes NAV information or by listening to the channel for at least a medium synchronization duration and finding the channel idle throughout the medium synchronization duration. In another implementation, an MPC/NPCA STA may support performing CS on a single channel at a time. Such a STA may be referred to as a non-concurrent CCA MPC/NPCA STA. In an implementation, the MPC/NPCA STA may perform CS on the PCH by default. The STA may perform CS on the NPCA PCH after switching from the PCH to the NPCA PCH. In contrast to a concurrent CCA MPC/NPCA STA, a non-concurrent CCA MPC/NPCA STA may only synchronize to the NPCA PCH after the PCH is found busy. Hence, it may need to listen to the channel for at least a medium synchronization duration (if it does not receive any frame that includes NAV information) before it is able to transmit.

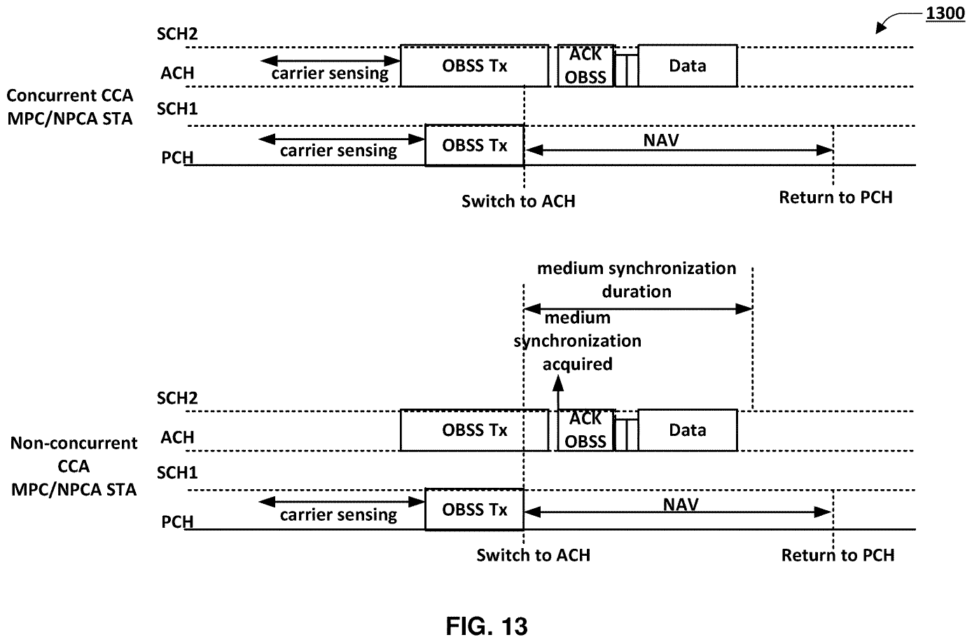

FIG. 13 is an example that contrasts the operation of a concurrent CCA MPC/NPCA STA and the operation of a non-concurrent CCA MPC/NPCA STA. As shown in FIG. 13, both the concurrent CCA MPC/NPCA STA and the non-concurrent MPC/NPCA STA may operate over a plurality of channels, including a primary channel (PCH), a first secondary channel (SCH1), an anchor channel (ACH), and a second secondary channel (SCH2). The concurrent CCA MPC/NPCA STA may perform concurrent CS on the PCH and the ACH. The non-concurrent CCA MPC/NPCA STA may perform CS on the PCH only.

The example of FIG. 13 may begin with the concurrent CCA MPC/NPCA STA or the non-concurrent CCA MPC/NPCA STA operating on the PCH. In an example, a first OBSS transmission may begin on the PCH. As both the concurrent CCA MPC/NPCA STA and the non-concurrent CCA MPC/NPCA STA perform CS on the PCH, both may detect the first OBSS transmission. In an implementation, on detecting the first OBSS transmission on the PCH, the concurrent CCA MPC/NPCA STA and the non-concurrent CCA MPC/NPCA STA may both be configured to set a NAV associated with the PCH (based on a duration of the first OBSS transmission) and to switch to the ACH for the duration of the NAV.

In an example, before or during the first OBSS transmission on the PCH, a second OBSS transmission may begin on the ACH. Having concurrent CS capability, the concurrent CCA MPC/NPCA STA may detect the second OBSS transmission before switching to the ACH. In an implementation, the concurrent CCA MPC/NPCA STA may set a NAV associated with the ACH based on the second OBSS transmission. The concurrent CCA MPC/NPCA STA may wait until an end of the second OBSS transmission (and any associated ACK frames) before attempting to access the ACH to transmit a data frame. The concurrent CCA MPC/NPCA STA may perform a random backoff before transmitting the data frame on the ACH. The concurrent CCA MPC/NPCA STA may switch back to the PCH when the NAV associated with the PCH reaches zero.

In contrast, the non-concurrent CCA MPC/NPCA STA may not detect the second OBSS transmission before switching to the ACH. On switching to the ACH, the non-concurrent CCA MPC/NPCA STA may thus not be aware of the second OBSS transmission being transmitted on the ACH. At the same time, the non-concurrent CCA MPC/NPCA STA may not have knowledge of a future time at which it may access the ACH. In an implementation, the non-concurrent MPC/NPCA STA may be configured to wait for at least a medium synchronization duration for the ACH, after switching to the ACH, before attempting to access the ACH, unless a transmission is detected by the STA during the medium synchronization duration. In an implementation, the non-concurrent MPC/NPCA STA may start a “MediumSyncDelay” timer for the medium synchronization duration, after switching to the ACH. In an implementation, the value of the “MediumSyncDelay” timer may be set to a “dot11MSDTimerDuration” value. The STA may initialize the “dot 11MSDTimerDuration” to an “aPPDUMaxTime” value as defined in Table 36-70 (EHT PHY characteristics) of the IEEE 802.11be draft amendment (“Draft P802.11be_D4.1”). The STA may update the “dot11MSDTimerDuration” with a value contained in a Medium Synchronization Delay Information field, if present, of a Basic Multi-Link element in the most recent frame received from its associated AP. In an implementation, the non-concurrent MPC/NPCA STA may reset the “MediumSyncDelay” timer to zero when the STA receives an MPDU or when the STA receives a PPDU for which the RXVECTOR parameter “TXOP_DURATION” is not set to “UNSPECIFIED.”

In the example of FIG. 13, the non-concurrent CCA MPC/NPCA STA may detect and receive an ACK frame associated with the second OBSS transmission, after switching to the ACH. Reception of the ACK frame allows the non-concurrent CCA MPC/NPCA STA to reset the “MediumSyncDelay” timer to zero and to acquire medium synchronization on the ACH. The non-concurrent CCA MPC/NPCA STA may wait for an end of the ACK frame before performing a random backoff to transmit a data frame on the ACH. The non-concurrent CCA MPC/NPCA STA may switch back to the PCH when the NAV associated with the PCH reaches zero.

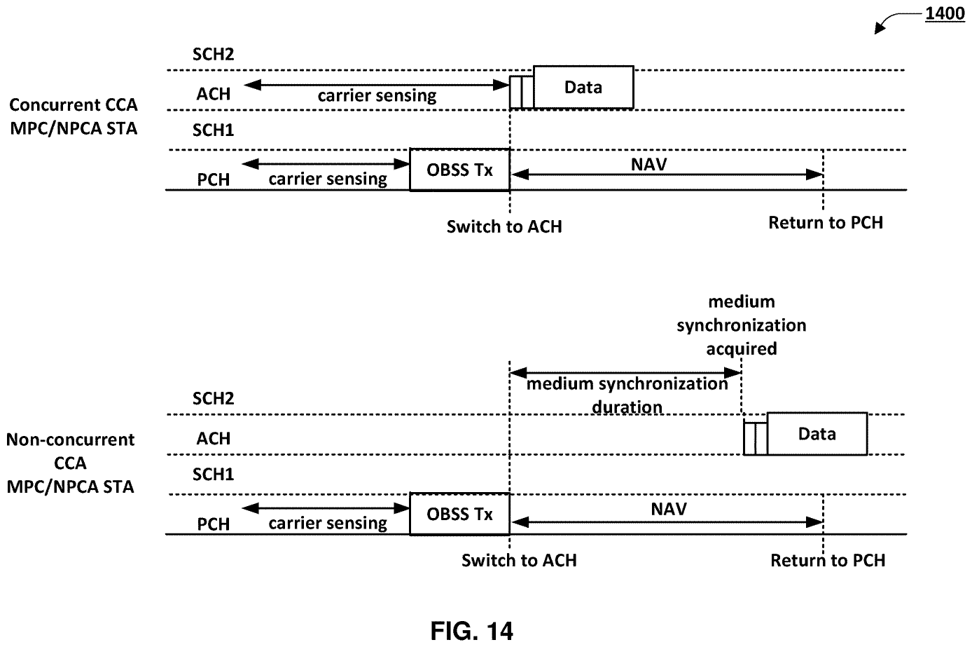

FIG. 14 is another example that contrasts the operation of a concurrent CCA MPC/NPCA STA and the operation of a non-concurrent CCA MPC/NPCA STA. As in the example of FIG. 13, both the concurrent CCA MPC/NPCA STA and the non-concurrent MPC/NPCA STA may operate over a plurality of channels, including a primary channel (PCH), a first secondary channel (SCH1), an anchor channel (ACH), and a second secondary channel (SCH2). The concurrent CCA MPC/NPCA STA may perform concurrent CS on the PCH and the ACH. The non-concurrent CCA MPC/NPCA STA may perform CS on the PCH only.

The example of FIG. 14 may begin with the concurrent CCA MPC/NPCA STA or the non-concurrent CCA MPC/NPCA STA operating on the PCH. In an example, a first OBSS transmission may begin on the PCH. As both the concurrent CCA MPC/NPCA STA and the non-concurrent CCA MPC/NPCA STA perform CS on the PCH, both may detect the first OBSS transmission. In an implementation, on detecting the first OBSS transmission on the PCH, the concurrent CCA MPC/NPCA STA and the non-concurrent CCA MPC/NPCA STA may both be configured to set a NAV associated with the PCH (based on a duration of the first OBSS transmission) and to switch to the ACH for the duration of the NAV.

In an example, the ACH may be idle at the time that the concurrent CCA MPC/NPCA STA or the non-concurrent CCA MPC/NPCA STA switches to the ACH. Having concurrent CS capability, the concurrent CCA MPC/NPCA STA may be aware that the ACH is idle when the concurrent CCA MPC/NPCA STA switches to the ACH. The concurrent CCA MPC/NPCA STA may thus attempt to access the ACH immediately after switching to the ACH. As shown in FIG. 14, the concurrent CCA may perform a random backoff before transmitting a data frame on the ACH. The concurrent CCA MPC/NPCA STA may switch back to the PCH when the NAV associated with the PCH reaches zero.

In contrast, on switching to the ACH, the non-concurrent CCA MPC/NPCA STA may not have knowledge of whether the ACH is idle or busy. In an implementation, the non-concurrent MPC/NPCA STA may be configured to wait for at least a medium synchronization duration for the ACH, after switching to the ACH, before attempting to access the ACH, unless a transmission is detected by the STA during the medium synchronization duration. In an implementation, the non-concurrent MPC/NPCA STA may start a “MediumSyncDelay” timer for the medium synchronization duration, after switching to the ACH. In an implementation, the value of the “MediumSyncDelay” timer may be set to a “dot11MSDTimerDuration” value. The STA may initialize the “dot11MSDTimerDuration” to an “aPPDUMaxTime” value as defined in Table 36-70 (EHT PHY characteristics) of the IEEE 802.11be draft amendment (“Draft P802.11be_D4.1”). The STA may update the “dot11MSDTimerDuration” with a value contained in a Medium Synchronization Delay Information field, if present, of a Basic Multi-Link element in the most recent frame received from its associated AP. In an implementation, the non-concurrent MPC/NPCA STA may reset the “MediumSyncDelay” timer to zero when the STA receives an MPDU or when the STA receives a PPDU for which the RXVECTOR parameter “TXOP_DURATION” is not set to “UNSPECIFIED.”

In the example of FIG. 14, the non-concurrent CCA MPC/NPCA STA may not detect or receive any frame during the medium synchronization duration. The non-concurrent CCA MPC/NPCA STA may thus not reset the “MediumSyncDelay” timer to zero. The non-concurrent CCA MPC/NPCA STA may only acquire medium synchronization on the ACH after the entire medium synchronization duration has elapsed. The non-concurrent CCA MPC/NPCA STA may thus have to wait for the entirety of the medium synchronization duration before attempting to access the ACH. This is despite the fact that the ACH is idle and available for use during the medium synchronization duration. Buffered data at the non-concurrent CCA MPC/NPCA STA may thus be delayed unnecessarily and the ACH may thus be under-utilized.

As described herein, an AP may transmit a first frame comprising a medium synchronization duration for a first channel. The first channel may be an anchor channel or an auxiliary primary channel. When the medium synchronization duration for the first channel starts, the AP may transmit a second frame via the first channel. The medium synchronization duration for the first channel may start when the AP receives a third frame indicating a transmission on a second channel. The transmission may be an OBSS transmission. The transmission may cause the AP to switch from the second channel to the first channel. The second channel may be a primary channel of the AP. The second frame may be transmitted during the medium synchronization duration for the first channel. The second frame allows a non-concurrent CCA MPC/NPCA STA to acquire medium synchronization on the first channel, without waiting for the entirety of the medium synchronization duration for the first channel.

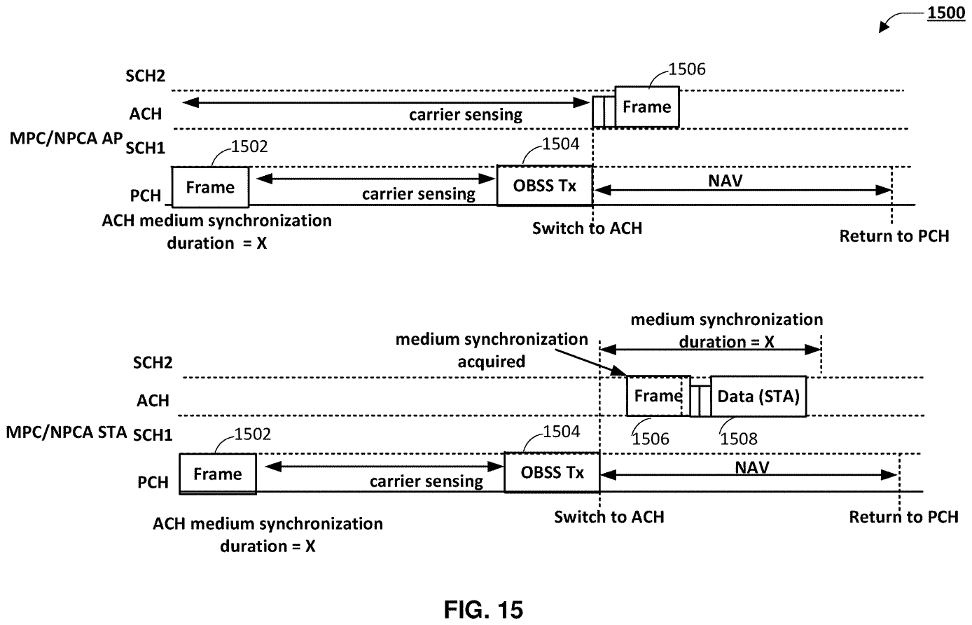

FIG. 15 illustrates an example procedure which may be performed by an AP in some circumstances. For illustration, FIG. 15 also shows the behavior of a STA, which may be associated with the AP, in response to the example AP procedure. The AP may operate over a plurality of channels, including a primary channel (PCH) and an anchor channel (ACH). In an example, the AP may further operate over a first secondary channel (SCH1) and a second secondary channel (SCH2). The AP may be capable of performing concurrent CS on the PCH and the ACH. The AP may support an anchor/auxiliary primary channel medium synchronization assistance mode, which allows the AP to perform the procedure of FIG. 15.

As shown in FIG. 15, the example procedure may begin with the AP operating on the PCH. In an example, the AP may transmit a frame 1502 on the PCH. Frame 1502 may be a management frame, such as a beacon frame. In some circumstances, frame 1502 may indicate the PCH and the ACH. In some circumstances, frame 1502 may comprise or indicate a medium synchronization duration for the ACH. In some circumstances, frame 1502 may comprise an indication of support by the AP of the anchor/auxiliary primary channel medium synchronization assistance mode. In some circumstances, frame 1502 may further comprise an indication of activation/deactivation of the anchor/auxiliary primary channel medium synchronization assistance mode by the AP. A STA associated with the AP may operate on the same channel as the AP. The STA may thus receive frame 1502 via the PCH.

In an example, while the AP is operating on the PCH, transmission of a frame 1504 from an OBSS may begin on the PCH. The AP may detect frame 1504 on the PCH. In an implementation, the AP may be configured to set a NAV associated with the PCH based on receiving frame 1504 on the PCH. Frame 1504 may indicate a transmission on the PCH. A duration of the transmission on the PCH may be provided by a duration field of frame 1504, a transmission opportunity (TXOP) duration field of a PPDU comprising frame 1504, or a length field of the PPDU. In an implementation, the AP may be configured to switch to the ACH for the NAV duration. In example circumstances, the AP may start a “MediumSyncDelay” timer for the medium synchronization duration of the ACH, after switching to the ACH. The “MediumSyncDelay” timer may be set based on the medium synchronization duration for the ACH indicated in frame 1504.

In some circumstances, after switching to the ACH, the AP may be configured to transmit a frame 1506 on the ACH during the medium synchronization duration for the ACH. In an implementation, the AP may be capable of concurrent CS on the PCH and the ACH. Thus, as shown in FIG. 15, the AP may transmit frame 1506 on the ACH (after performing a random backoff) without waiting for expiration of the medium synchronization duration for the ACH. Frame 1506 may be any frame, including a CTS frame, a contention free (CF) end frame, a trigger frame, a QoS data/null frame, or a null data packet (NDP) frame.

In an implementation, the AP may determine a CCA state of the ACH before transmitting frame 1506. In an implementation, the AP may transmit frame 1506 on condition of the CCA state of the ACH being idle. In an implementation, the AP may transmit frame 1506 on condition of the CCA state of the ACH being idle for a first duration before the AP receives frame 1504 on the PCH. In an implementation, the CCA state of the ACH being idle comprises a received power measured by the AP on the ACH, during the first duration, being less than a threshold. The first duration may be one of 5.484 milliseconds, 25 microseconds, or 16 microseconds, for example. The threshold may be one of −62 dBm, −72 dBm, or −82 dBm, for example. In some circumstances, the CCA state of the ACH being idle comprises a NAV associated with the ACH being equal to zero.

In some circumstances, the AP may transmit frame 1506 on the ACH on condition of a backoff count associated with the ACH being zero. The backoff count may be initialized to a random number by the AP. The backoff count may be initialized by the AP after an end of a PPDU carrying frame 1504 on the PCH; an indication of a successful preamble detection; or an indication of a successful MPDU detection on the PCH.

A STA associated with the AP may also detect and receive frame 1504 on the PCH. Like the AP, the STA may be configured to set a NAV associated with the PCH based on receiving frame 1504 on the PCH. In an implementation, the STA may also be configured to switch to the ACH for the NAV duration along with the AP. In an implementation, the STA may be configured to switch to the ACH when the STA is an MPC/NPCA STA. In some circumstances, the STA may start a “MediumSyncDelay” timer for the medium synchronization duration of the ACH, after switching to the ACH. The “MediumSyncDelay” timer may be set based on the medium synchronization duration for the ACH indicated in frame 1502.

In an example, as shown in FIG. 15, the STA may be a non-concurrent CCA MPC/NPCA STA. On switching to the ACH, the STA may not be aware of whether a transmission is taking place on the ACH. The STA may be configured to wait for the “MediumSyncDelay” timer to expire before attempting to access the ACH. The transmission by the AP of frame 1506, however, allows the non-concurrent CCA MPC/NPCA STA to acquire medium synchronization on the ACH. Specifically, on receiving frame 1506, the STA may reset the “MediumSyncDelay” timer to zero. The STA may then proceed to access the ACH, after performing a random backoff, to transmit a frame 1508 on the ACH. Frame 1508 may be a QoS data/null frame, for example. In an example, frame 1508 may be in response to frame 1506. For example, frame 1506 may be a trigger frame that triggers transmission of frame 1508 by the STA.

In some circumstances, the STA may transmit frame 1508 on the ACH on condition of a backoff count associated with the ACH being zero. The backoff count may be initialized to a random number by the STA. The backoff count may be initialized by the STA after an end of a PPDU carrying frame 1504 on the PCH; an indication of a successful preamble detection; or an indication of a successful MPDU detection on the PCH.

In another example, the STA may be a concurrent CCA MPC/NPCA STA. The STA may be capable of concurrent CS on the PCH and the ACH. In an implementation, the STA may determine a CCA state of the ACH. A CCA state may include a physical CS state and a virtual CS state. The CCA state may be considered idle when both the physical CS state and the virtual CS state indicate that the channel is idle. In some circumstances, the STA may transmit frame 1506 (e.g., together or in place of the AP) on condition of the CCA state of the ACH being idle. In an implementation, the STA may transmit frame 1506 on condition that the anchor/auxiliary operations channel medium synchronization assistance mode is activated by the AP. In an implementation, the STA may transmit frame 1506 on condition of the CCA state of the ACH being idle for a first duration before the STA receives frame 1504 on the PCH. In an implementation, the CCA state of the ACH being idle comprises a received power measured by the STA on the ACH, during the first duration, being less than a threshold. The first duration may be one of 5.484 milliseconds, 25 microseconds, or 16 microseconds, for example. The threshold may be one of −62 dBm, −72 dBm, or −82 dBm, for example. In some circumstances, the CCA state of the ACH being idle comprises a NAV associated with the ACH being equal to zero.

In some circumstances, the STA may transmit frame 1506 on the ACH on condition of a backoff count associated with the ACH being zero. The backoff count may be initialized to a random number by the STA. The backoff count may be initialized by the STA after an end of a PPDU carrying frame 1504 on the PCH; an indication of a successful preamble detection; or an indication of a successful MPDU detection on the PCH.

In some circumstances, the STA transmits frame 1506 simultaneously with the AP. In this example, frame 1506 may be of a specific frame type that is known to both AP and STA. In some circumstances, the backoff count associated with the ACH may be initialized to a value that is known to both AP and STA (e.g., 0).

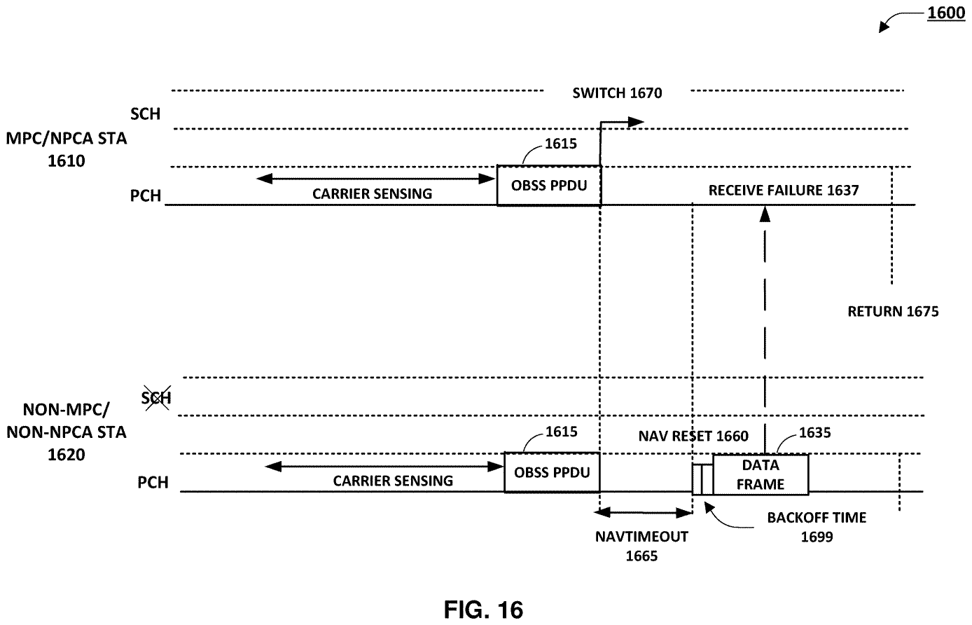

FIG. 16 illustrates an example procedure 1600 that illustrates a problem that may arise in some circumstances by the operation of MPC/NPCA STAs and non-MPC/non-NPCA STAs. Procedure 1600 depicts operation of, and interactions between, STAs in a wireless network, e.g., MPC/NPCA STA 1610 and non-MPC/non-NPCA STA 1620. As shown, MPC/NPCA STA 1610 may operate over a plurality of channels, including a primary channel (PCH) and a secondary channel (SCH), while non-MPC/non-NPCA STA 1620, not having multi primary channel capability only operates over the PCH, and is shown as such. As described herein, SCHs may also be referenced as auxiliary channels. For example, without limitation, the PCH may correspond to a primary 20 MHz channel, and the SCH may correspond to a secondary 20 MHz channel.

With respect to MPC/NPCA STA 1610, as discussed with FIGS. 10-11 above, it is envisioned future IEEE 802.11 standards will enable a STA to operate with multiple primary channels (e.g., channels of operation), in some circumstances. It will be apparent to persons skilled in the relevant art, given the description herein, that providing a STA with the capability of switching between multiple primary channels may, in some circumstances provide benefits that may include, but are not limited to, improving the performance of the STA, e.g., by providing a capability to switch to a second channel to avoid traffic detected on a first channel.

In some approaches to implementing MPC/NPCA STAs, when a certain type of communication (e.g., a frame) is detected on a current channel of operation, an MPC/NPCA STA may immediately switch to an auxiliary channel. For example, as depicted in FIG. 16, while performing CS on the PCH, MPC/NPCA STA 1610 may detect an OBSS PPDU 1615 relative to the BSS of MPC/NPCA STA 1610. As a result, MPC/NPCA STA 1610 is depicted at switch 1670 as switching immediately the channel of operation from the PCH to the SCH.

For the purposes of this example, OBSS PPDU 1615 corresponds to a Request-to-Send (RTS) or a Multi-User RTS (MU-RTS) type of frame, but this example is non-limiting, and other types of frames may have similar handling by embodiments.

In addition to the operation of MPC/NPCA STA 1610, for illustrative purposes, the operation of non-MPC/non-NPCA STA 1620 is also depicted as detecting OBSS PPDU 1615 via carrier sensing. In this example, because non-MPC/non-NPCA STA 1620 is not an MPC/NPCA STA, non-MPC/non-NPCA STA 1620 remains with the PCH as its channel of operation upon detecting OBSS PPDU 1615. Non-MPC/non-NPCA STA 1610 may set its NAV based on detecting OBSS PPDU 1615. In addition, non-MPC/non-NPCA STA 1610 may start a timer corresponding to a NAVTimeout period 1655. NAVTimeout 1655 may be equal to the NAV timeout as defined in the IEEE 802.11 standard.

As noted above, in this example, OBSS PPDU 1615 corresponds to an RTS or an MU-RTS frame, and as a further element of this example, it is assumed that no clear to send (CTS) frame is detected by non-MPC/non-NPCA STA 1620 within NAVTimeout 1655 following detecting of OBSS PPDU 1615. As mentioned above, in accordance with the IEEE 802.11 standard, because OBSS PPDU 1615 is an RTS or an MU-RTS frame, and no CTS frame is detected within NAVTimeout 1665, non-MPC/non-NPCA STA 1620 may reset its NAV set based on OBSS PPDU 1615.

Continuing this example operation of non-MPC/non-NPCA STA 1620 relative to MPC/NPCA STA 1610 and the PCH and SCH channels, based on the expiration of NAVTimeout 1665, NAV reset 1660 may occur and, in this example, after a backoff time 1699, non-MPC/non-NPCA STA 1620 may transmit a data frame 1635 to MPC/NPCA STA 1610. In some implementations, this data frame 1635 frame may correspond to an RTS frame for the transmission of additional data.

In an example that illustrates potential problems that may occur given the circumstances described above, as depicted in the timelines of MPC/NPCA STA 1610 and non-MPC/non-NPCA STA 1620, because the transmission of data frame 1635 occurs while MPC/NPCA STA 1610 is operating on SCH, MPC/NPCA STA 1610 may fail to receive data frame 1635, resulting in a receive failure 1637 for the transmission of data frame 1635. In some circumstances, this failure may cause network performance degradation for non-MPC/non-NPCA STAs that are associated with MPC/NPCA STAs.

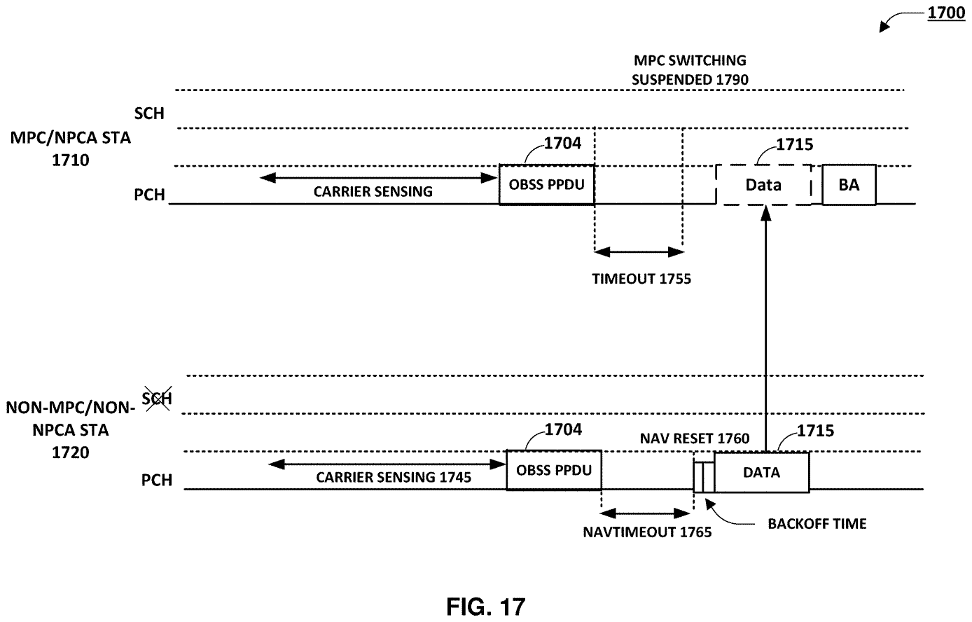

Embodiments of the present disclosure, as described below, address one or more of the above-described problems. In an example the references the example of FIG. 17 below, a method corresponding to embodiments may include, receiving, by a first STA from a second STA and via a first channel, a first frame comprising an indication of a frame type of the first frame. In this example, the first STA may correspond to MPC/NPCA STA 1710, which may receive (e.g., detect) the first frame corresponding to an RTS type frame, e.g., a type of OBSS PPDU 1704.

In embodiments, the method may further include, after receiving the first frame, based on the frame type, switching a channel of operation of the first STA, from the first channel to a second channel. For example, as described with FIG. 17 below, detection of a frame of the RTS frame type by MPC/NPCA STA 1710, may cause a delay in the switching of MPC/NPCA STA 1710 in certain circumstances. In an embodiment, this delay in switching may result in MPC/NPCA STA 1710 not switching to the SCH (e.g., switching 1670), and this may result in MPC/NPCA STA 1710 being able to detect data 1715 and avoid problems associated with a receive failure, e.g., such as receive failure 1637. Additional details regarding different approaches to implementing the switching delay, the second frame, and additional operations of non-MPC/non-NPCA STAs, are discussed with FIGS. 17-21 below.

FIG. 17 illustrates an example procedure 1700 which may be performed by an embodiment, e.g., to mitigate one or more of the above-described problems that may arise in some circumstances by the operation of MPC/NPCA STAs and non-MPC/non-NPCA STAs. For example, as depicted in FIG. 17, by performing CS on the PCH, an OBSS PPDU 1704 relative to the BSS of MPC/NPCA STA 1710 and non-MPC/non-NPCA STA 1720 may be detected.

In the example of FIG. 16, because MPC/NPCA STA 1610 does not switch back to the PCH, network performance may be negatively impacted, based on a receive failure 1637 occurring in some circumstances. Embodiments of the present disclosure, as further described below, address one or more of the above-described problems. Generally speaking, one or more embodiments may improve the likelihood that an MPC/NPCA STA receives data from a non-MPC/non-NPCA STA that has a NAV reset (e.g., after receiving an OBSS PPDU frame on the PCH). In an approach that may be u by an embodiment, an MPC/NPCA AP (and MPC/NPCA STAs generally) may wait for a selected timeout period, before switching from the PCH to the SCH.

At the time of MPC/NPCA STA 1710 switching, one approach to regulating the switching of an MPC/NPCA STA involves the determination of a duration of a timeout 1755. Timeout 1755 may correspond to a minimum duration for which MPC/NPCA STA 1710 may continue to operate on the PCH after receiving OBSS PPDU 1704. As discussed herein, the value of timeout 1755 may be determined in different ways, but the determining generally involves a determination whether the NAV on the PCH may be reset or not after receiving OBSS PPDU 1704. For example, based on the frame being detected being of an OBSS PPDU 1704 type (e.g. RTS or MU-RTS), the PCH NAV may be determined to be reset at the end of NAVTimeout 1765.

In the example depicted, NAVTimeout 1765 may be selected to regulate the use of the PCH for communications by non-MPC/non-NPCA STA 1720, given the detection of OBSS PPDU 1704 by non-MPC/non-NPCA STA 1720. NAVTimeout 1765 may be determined in different ways, but the determining generally involves an estimate when the PCH will be free of signals associated with communications detected on the PCH (e.g., OBSS PPDU 1704) and thus will be able to be used by non-MPC/non-NPCA STA 1620 (e.g. by resetting the NAV set by OBSS PPDU 1704).

In an embodiment, rather than switching immediately to the SCH upon detecting OBSS PPDU 1704 on the PCH, MPC/NPCA STA 1710 may be configured to continue operating on the PCH for at least timeout 1755 after receiving OBSS PPDU 1704, before switching to the SCH. In an implementation, a duration of timeout 1755 may be set to be equal to or greater than the duration of a NAV timeout (NAVTimeout) as defined in the IEEE 802.11 standard. This ensures that MPC/NPCA STA 1710 continues to operate on the PCH, after receiving OBSS PPDU 1704. In an example, timeout 1755 may be set to correspond to a PCH NAV (e.g., NAVTimeout 1765) set based on OBSS PPDU 1704, and the PCH NAV may be reset in accordance with the IEEE 802.11 standard. For instance, according to the IEEE 802.11 standard, a STA that used information from an RTS frame or an MU-RTS Trigger frame as the most recent basis to update its NAV setting is permitted to reset its NAV if no PHY-RXEARLYSIG. indication or PHYRXSTART.indication primitive is received from the PHY during a NAV timeout period starting when the MAC receives a PHY-RXEND.indication primitive corresponding to the detection of the RTS frame or MU-RTS Trigger frame. That is, the STA may reset its NAV, set based on an RTS or an MU-RTS Trigger frame, if the STA does not receive any frame during a NAV timeout interval from the time the STA sets the NAV. Hence, the NAV timeout may be used as a value for timeout 1755, e.g., to set a limit for the time MPC/NPCA STA 1710 will evaluate whether to switch the channel of operation of MPC/NPCA STA 1710 to the SCH. In different implementations, the value of timeout 1755 may correspond to the following times associated with events of the PCH: (2×aSIFSTime)+(CTS_Time)+aPHY-RX-START-Delay+(2×aSlotTime), where CTS_Time comprises a duration of the PPDU carrying the CTS frame.

In an embodiment, a method used may include, receiving, by a first STA from a second STA and via a first channel, a first frame comprising an indication of a frame type of the first frame. In an embodiment, based on the frame type, the first STA may switch a channel of operation. For example, as depicted in example procedure 1700, after MPC/NPCA STA 1710 receives the OBSS PPDU 1704, and based on a frame type of OBSS PPDU 1704 being a particular type (e.g., an RTS frame type or an MU-RTS frame type), MPC/NPCA STA 1710 may switch (or delay switching) its channel of operation from the PCH to the SCH. One approach that may be utilized by embodiments to determine when (or whether) MPC/NPCA STA 1710 switches to the SCH utilizes a timeout period determined by an embodiment, e.g., timeout 1755 described below.

For example, because in an embodiment, MPC/NPCA STA 1710 may remain with the PCH as a channel of operation after receipt of OBSS PPDU 1704 for at least the timeout, MPC/NPCA STA 1710 may detect a lack of receiving a frame that would be expected to follow the receipt of OBSS PPDU 1704. For example, where OBSS PPDU 1704 is an RTS or an MU-RTS frame, MPC/NPCA STA 1710 may detect a lack of receiving a frame that would be expected to follow the receipt of the RTS or MU-RTS frame.

Because, in an embodiment, MPC/NPCA STA 1710 maintains the PCH as its operating channel, information may be received from the PCH and used to determine whether MPC/NPCA STA 1710 switches to the SCH after receipt of OBSS PPDU 1704.

In an embodiment, MPC/NPCA STA 1710 may select timeout 1755 based on a time that a CTS would be expected to be detected on the PCH, and when timeout 1755 expires without MPC/NPCA STA 1710 receiving any following transmission on the PCH, MPC/NPCA operation may be suspended 1790. In the example depicted, because no following frame is detected by MPC/NPCA STA 1710 during the determined timeout 1755, MPC/NPCA operation may be suspended 1790 and MPC/NPCA STA 1710 does not continue monitoring PCH so as to switch to an auxiliary channel, e.g., SCH. As depicted on the timeline, this lack of switching by MPC/NPCA STA 1710 may beneficially facilitate the receipt of data 1715 from non-MPC/non-NPCA STA 1720, e.g., as compared to the return 1675 to the PCH, described for MPC/NPCA STA 1610 with FIG. 16 above.

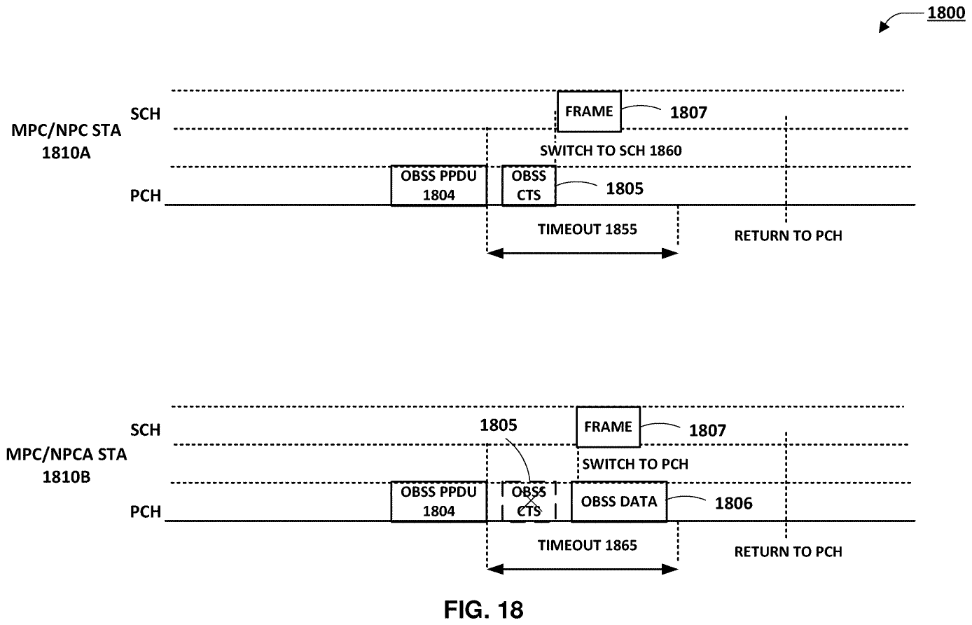

FIG. 18 illustrates an example procedure 1800 which may be performed by MPC/NPCA components, according to an embodiment. As noted with the example of FIG. 17 above, one or more embodiments may beneficially delay an MPC/NPCA STA from a switching to a secondary channel in some circumstances. In the example procedure 1700 described with FIG. 17 above, because a particular frame type was not detected by MPC/NPCA STA 1710 (e.g., an OBSS CTS frame following OBSS PPDU 1704 frame), MPC/NPCA STA 1710 did not switch to the SCH after detection of OBSS PPDU 1704.

In example procedure 1800, during the timeout 1855 within which MPC/NPCA STA 1810A may determine whether a frame following OBSS PPDU 1804 is received, OBSS CTS 1805 is detected. In accordance with one or more embodiments, detection of OBSS CTS 1805 during timeout 1855 may cause MPC/NPCA STA 1810A to switch 1860 to the SCH. As depicted in FIG. 18, this switch may occur based on an end of the OBSS CTS 1805 frame, e.g., an end of the PPDU carrying OBSS CTS 1805 frame. In an alternative embodiment not shown in FIG. 18, the switch 1860 point of MPC/NPCA STA 1810A to the SCH may be the end of a preamble of a PPDU carrying the OBSS CTS 1805 frame, e.g., after a PHY-RXSTART.indication is received.

As depicted, based on the switch to SCH, in this example, MPC/NPCA STA 1810A may communicate frame 1807 via the SCH. In an additional or alternative embodiments not depicted in FIG. 18, before frame 1807 is communicated using the SCH, MPC/NPCA STA 1810A may perform a medium synchronization procedure on the SCH or receive an indication that a medium synchronization procedure has been performed for the SCH.

Continuing the discussion of example procedure 1800, during the timeout 1865, within which MPC/NPCA STA 1810B may determine whether a following frame has been received, as depicted, in this example, OBSS CTS 1805 is not detected. In additional or alternative embodiments, instead of the OBSS CTS 1805 frame that caused MPC/NPCA STA 1810A to switch, the detection of OBSS data 1806 frame may cause MPC/NPCA STA 1810B to switch to the SCH. In variations of this approach using detection of OBSS data 1806 frame, embodiments may be configured to switch from the PCH to the SCH based on events including, but not limited to, the end of a PPDU carrying the OBSS data 1806 frame, the end of the preamble of the PPDU carrying the OBSS data 1806 frame (e.g., PHY-RXSTART.indication), the end of an orthogonal frequency division multiplexing (OFDM) symbol of the first MPDU carrying the OBSS data 1806 frame, and/or other events that are relevant to the switching determinations described herein.

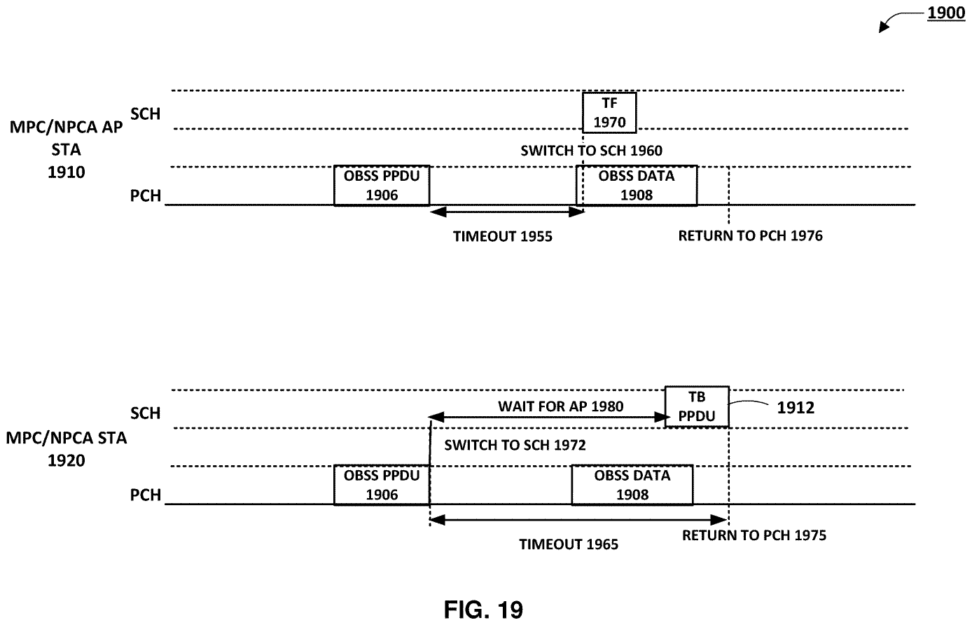

FIG. 19 illustrates an example procedure 1900 which may moderate interactions between MPC/NPCA components in a wireless network, according to an embodiment. As described above, in an implementation of MPC/NPCA components, based on certain OBSS communications being detected on the PCH, MPC/NPCA components may switch from the PCH to the SCH.

For example, as depicted in FIG. 19, upon detection of OBSS PPDU 1906, MPC/NPCA STA 1910 may switch 1960 to PCH. As discussed above and depicted in FIG. 19, in an embodiment, upon detection of OBSS PPDU 1906, MPC/NPCA AP STA 1910 may delay switching to the PCH until a condition described above, such as detection of a CTS communication following OBSS PPDU 1906. Example following communications include the depicted OBSS data 1806 and OBSS CTS 1805 of FIG. 18, as discussed with FIG. 18 above.

In an embodiment, based on detection of OBSS PPDU 1906, MPC/NPCA STA 1920 may switch 1972 to SCH, and MPC/NPCA AP STA 1910 may commence timeout 1955. With reference to medium channel synchronization, MPC/NPCA STA 1920 may wait 1980 for MPC/NPCA AP STA 1910 to transmit a frame on the SCH such that MPC/NPCA STA 1920 may achieve medium synchronization on the SCH. In an embodiment, to facilitate providing access to the SCH to MPC/NPCA STA 1920 and other devices, once MPC/NPCA AP 1921 has detected OBSS data 1908 and switched 1960 to the SCH, Trigger Frame (TF) 1970 may be transmitted on the SCH to provide SCH medium synchronization to MPC/NPCA STA 1920 and other devices, e.g., to be detected by MPC/NPCA STA 1920. In an alternative embodiment, instead of using the transmission of TF 1970 to indicate synchronization, to provide synchronization aid to associated STAs for the SCH, MPC/NPCA AP STA 1910 may communicate a DL frame (not shown) on the SCH, e.g., to be detected by MPC/NPCA STA 1920.

Based on the indication of medium synchronization, MPC/NPCA STA 1920 may respond to TF 1970 with Trigger-Based Physical Protocol Data Unit 1912 (TB PPDU), before returning 1975 to the PCH, e.g., after expiration of the NAV in the PCH, such as one described with the determination of NAV for non-AP stations discussed with FIGS. 13-15 above. In addition, as depicted, after expiration of a timeout period, MPC/NPCA AP STA 1910 may return 1976 to the PCH.

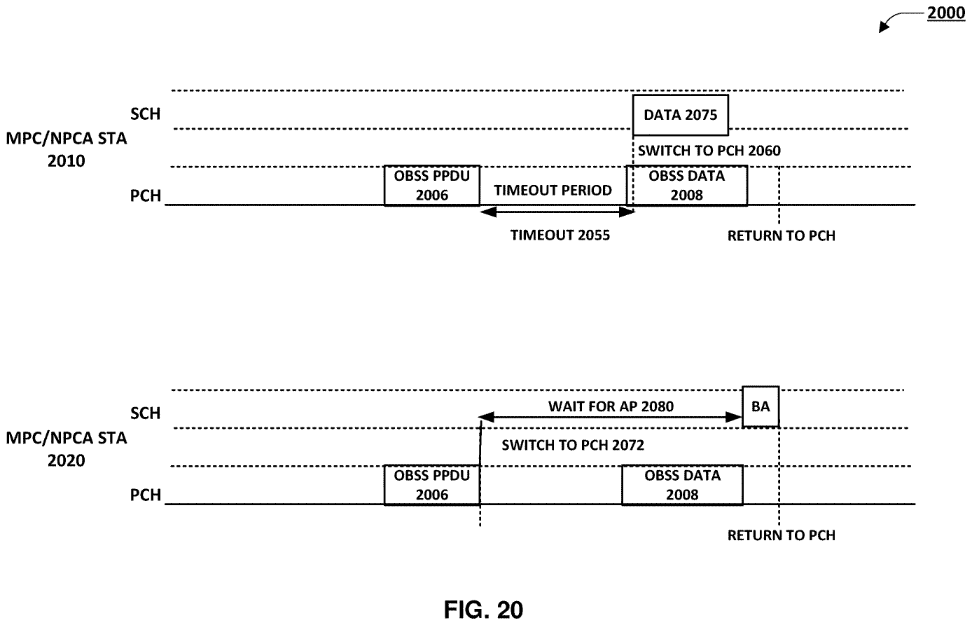

FIG. 20 illustrates an additional example procedure 2000 which may moderate interactions between MPC/NPCA components in a wireless network, according to an embodiment. In an implementation of MPC/NPCA components, based on certain OBSS communications being detected on the PCH, MPC/NPCA components may switch from the PCH to the SCH.

For example, as depicted in FIG. 20, upon detection of OBSS PPDU 2006, MPC/NPCA STA 2010 may switch 2072 to the PCH. As discussed above and depicted in FIG. 20, in an embodiment, upon detection of OBSS PPDU 2006, MPC/NPCA STA 2010 may delay switching to the PCH until a condition described above, such as detection of a communication following OBSS PPDU 2006.

In an embodiment, after MPC/NPCA STA 2010 detects OBSS data 2008 before the expiration of timeout 2055, MPC/NPCA STA 2010 may switch to the SCH. In this example, instead of communicating TF 1970 to indicate channel synchronization to MPC/NPCA STA 2020, data 2075 may be communicated on the SCH by MPC/NPCA STA 2010 to indicate synchronization.

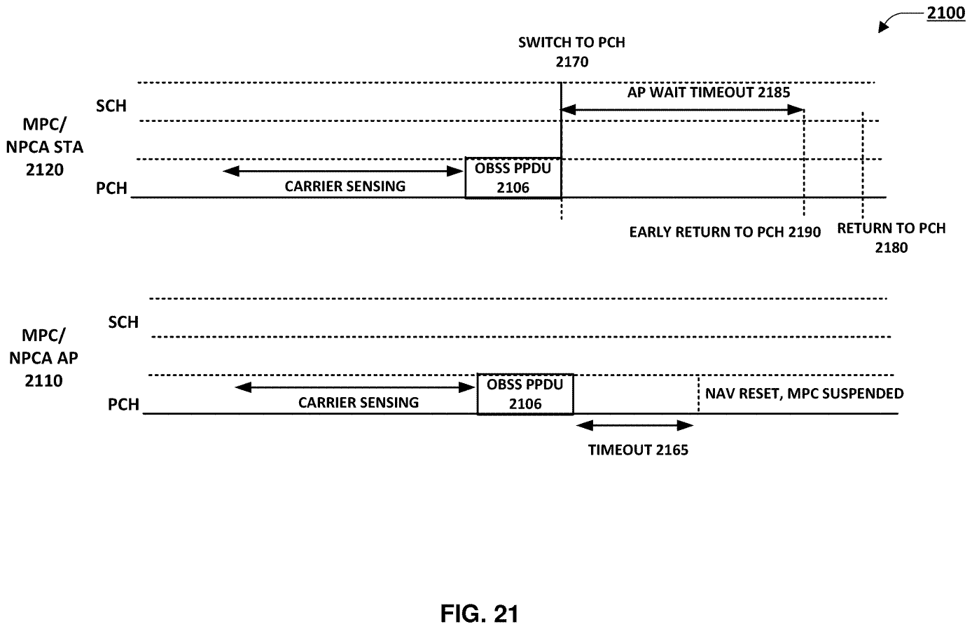

FIG. 21 illustrates an additional example procedure 2100 which may moderate interactions between MPC/NPCA components in a wireless network, according to an embodiment. In an implementation of MPC/NPCA components, based on certain OBSS communications being detected on the PCH, MPC/NPCA components may switch from the PCH to the SCH.

As depicted in FIG. 21, because timeout 2165 expires before receipt of a following frame, the NAV of MPC/NPCA AP 2110 may be reset and MPC/NPCA operation of MPC/NPCA AP 2110 may suspended. In this example embodiment, MPC/NPCA STA 2120 switched 2170 to the PCH upon detection of OBSS PPDU 2106, but because MPC/NPCA AP 2110 did not switch to the SCH, no synchronizing TF 1970 was communicated on the SCH. With no indication of synchronization, after the expiration of AP wait timeout 2185, MPC/NPCA STA 2120 may perform an early return 2190 to the PCH. Generally speaking, in an embodiment, early return 2190 time may be selected to be, as depicted, after MPC/NPCA 2110 timeout 2165 and before return 2180 to PCH. For example, in an implementation, AP wait timeout 2185 may comprise a duration equal to MPC/NPCA AP 2110 timeout 2165, plus the time it may take for MPC/NPCA AP 2110 to switch from the PCH to SCH and transmit a frame, plus any other timing parameters, e.g., aRxPHYStartDelay.

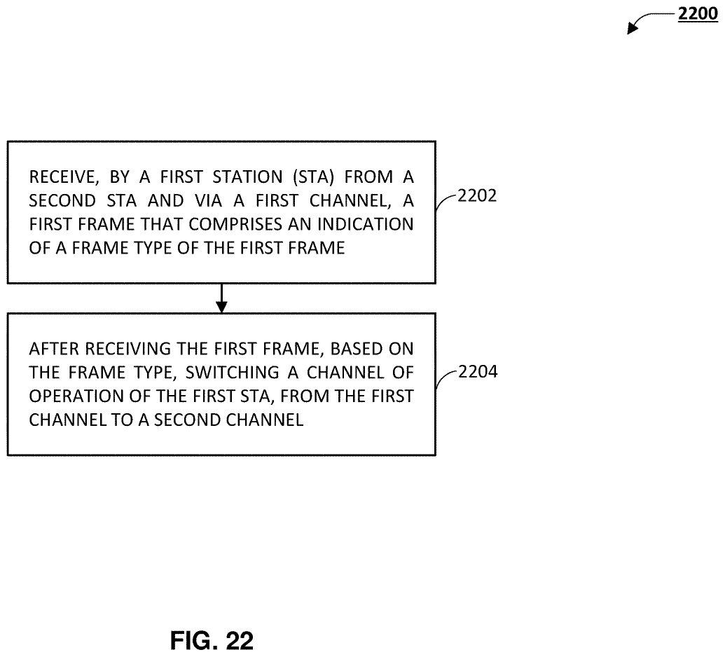

FIG. 22 illustrates an example process 2200 according to an embodiment. Example process 2200 may be performed by a first STA, e.g., MPC/NPCA STA, such as the MPC/NPCA STAs described above with reference to FIGS. 16-21. The MPC/NPCA STA may operate over a plurality of channels, including a first channel and a second channel, e.g., a primary channel and a secondary (auxiliary) channel, respectively, as described above with reference to FIGS. 16-21.

As shown in FIG. 22, process 2200 may include step 2202 and step 2204. At step 2202 the process depicted may include receiving, by a first station (STA) from a second STA and via a first channel, a first frame that comprises an indication of a frame type of the first frame. In an embodiment, the first STA or the second STA may comprise an ultra-high reliability STA. In an embodiment, a frame type of the first frame may comprise a request to send (RTS) frame or a multi-user request to send (MU-RTS) frame. At step 2204 the process depicted may further include after receiving the first frame, based on the frame type, switching a channel of operation of the first STA, from the first channel to a second channel.

In an embodiment, process 2200 may further include, transmitting, at a transmission start time based on the indication, by the first STA and via a second channel, a second frame. In an embodiment, the indication may comprise a first duration, with the transmission start time being based on transmitting the second frame before an end of the first duration. In an embodiment, the first duration may comprise a transmit opportunity (TXOP) duration.

In an embodiment, the transmission start time may be based on a timeout period that commences after receiving the first frame. In an embodiment, the timeout period may comprise a NAVTimeout period. In an embodiment, the switching may occur after the timeout period, or alternatively, the switching may occur during the timeout period.

In an embodiment, process 2200 may further include, detecting a third frame via the first channel, with the switching of the channel of transmission to the second channel occurring after the of receiving the third frame. In an embodiment, the switching to the second channel may be based on the receiving of the third frame. In an embodiment, the switching may occur based on the receiving of the third frame during the timeout period. In an embodiment, the third frame comprises a physical layer protocol data unit (PPDU), the switching of the channel of transmission may occur after one of, an end of a preamble portion of the PPDU, an end of transmission of the PPDU, and an end of an orthogonal frequency division multiplexing (OFDM) symbol of the PPDU.

In additional or alternative embodiments, a frame type of the third frame may be one of, a data frame, a management frame, a clear to send (CTS) frame, a block acknowledgement request (BAR) frame, and null data packet (NDP) announcement frame. In an embodiment, the first channel may correspond to a physical channel of a physical layer (PHY) associated with the first channel, and the receiving of the third frame may comprise, receiving via the physical channel, during the timeout period, a PHY-RXEARLYSIG indication primitive or a PHYRXSTART indication primitive.

In additional or alternative embodiments, the first STA may comprise a multiple channel access point (MPC/NPCA AP) STA, the first channel may comprise a primary channel, and the second channel may comprise an auxiliary channel. In an embodiment, process 2200 may further comprise, after the receiving of the first frame and before the switching to the auxiliary channel, detecting, from a non-MPC/non-NPCA non-AP station, a communication via the primary channel. In an embodiment, the second STA may comprise an MPC/NPCA non-AP STA that switched to the auxiliary channel upon concurrent receipt of the first frame with the MPC/NPCA AP STA, and the second frame may comprise an indication frame, with the indication frame indicating to the MPC/NPCA non-AP STA that the auxiliary channel is available for communication with the MPC/NPCA AP STA. In an embodiment, the indication frame comprises a downlink (DL) frame. In an embodiment, the indication frame may indicate to the MPC/NPCA non-AP STA that the MPC/NPCA AP STA has performed a media channel synchronization on the auxiliary channel. In an embodiment, the indication frame may comprise a trigger frame.

In additional or alternative embodiments, the first STA may comprise a MPC/NPCA non-AP STA, and the second STA may comprise a MPC/NPCA AP station, the first channel comprises a primary channel, and the second channel may comprise an auxiliary channel. In an embodiment, process 2200 may further comprise, based on the indication and upon receipt of the first frame concurrently with the MPC/NPCA AP station, switching to the auxiliary channel. In an embodiment, process 2200 may further comprise, receiving an indication frame via the auxiliary channel, wherein the transmitting of the second frame is based on the trigger frame. In an embodiment, the indication frame may have been transmitted by the MPC/NPCA AP station and indicates to the MPC/NPCA non-AP station that the auxiliary channel is available for communication. In an embodiment, indication frame indicates that the MPC/NPCA AP STA has performed a media channel synchronization on the auxiliary channel. In an embodiment, the indication frame may comprise at least one of, a management frame, a clear to send (CTS) frame, a block acknowledgement request (BAR) frame, and null data packet (NDP) announcement frame.

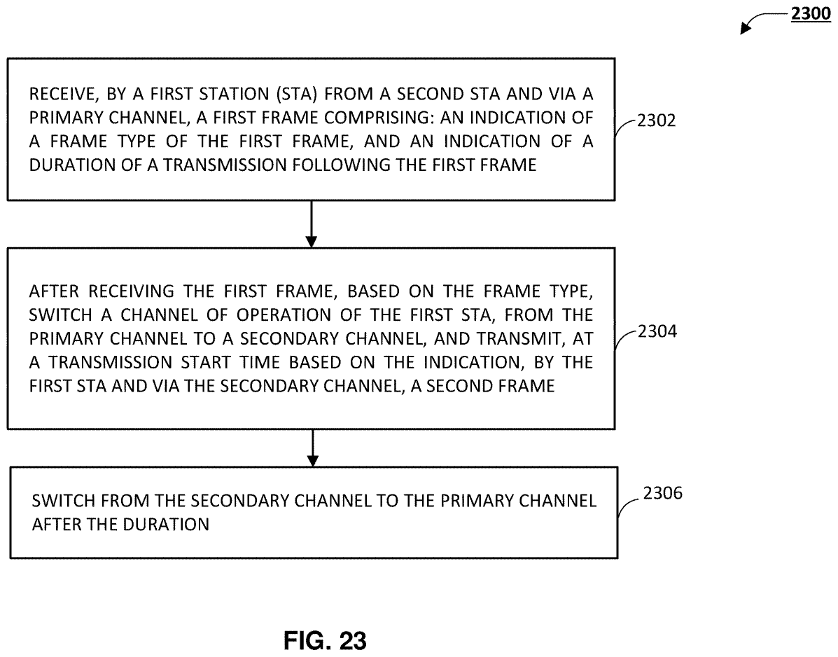

FIG. 23 illustrates an example process 2300 according to an embodiment. Example process 2300 may be performed by a first STA, e.g., an MPC/NPCA STA, such as the MPC/NPCA STAs described above with reference to FIGS. 16-21. The MPC/NPCA STA may operate over a plurality of channels, including a first channel and a second channel, e.g., a primary channel and a secondary (auxiliary) channel, respectively, as described above with reference to FIGS. 16-21.

As shown in FIG. 23, process 2300 may include step 2302, step 2304, and step 2306. At step 2302 the process depicted may include, receiving, by a first station (STA) from a second STA and via a primary channel, a first frame comprising: an indication of a frame type of the first frame, and an indication of a duration of a transmission following the first frame. At step 2304, process step 2300 depicted may further include, after receiving the first frame: based on the frame type, switching a channel of operation of the first STA, from the primary channel to a secondary channel, and transmitting, at a transmission start time based on the indication, by the first STA and via the secondary channel, a second frame. At step 2306, process 2300 depicted may further include switching from the secondary channel to the primary channel after the duration.

In an embodiment, the indication may comprise a first duration, with the transmission start time being based on transmitting the second frame before an end of the first duration. In an embodiment, the first duration may comprise a transmit opportunity (TXOP) duration.

In an embodiment, the transmission start time may be based on a timeout period that commences after receiving the first frame. In an embodiment, the timeout period may comprise a NAVTimeout period. In an embodiment, the switching may occur after the timeout period, or alternatively, the switching may occur during the timeout period.

In an embodiment, process 2300 may further include, detecting a third frame via the first channel, with the switching of the channel of transmission to the second channel occurring after the of receiving the third frame. In an embodiment, the switching to the second channel may be based on the receiving of the third frame. In an embodiment, the switching may occur based on the receiving of the third frame during the timeout period. In an embodiment, the third frame comprises a physical layer protocol data unit (PPDU), the switching of the channel of transmission may occur after one of, an end of a preamble portion of the PPDU, an end of transmission of the PPDU, and an end of an orthogonal frequency division multiplexing (OFDM) symbol of the PPDU.

In additional or alternative embodiments, a frame type of the third frame may be one of, a data frame, a management frame, a clear to send (CTS) frame, a block acknowledgement request (BAR) frame, and null data packet (NDP) announcement frame. In an embodiment, the first channel may correspond to a physical channel of a physical layer (PHY) associated with the first channel, and the receiving of the third frame may comprise, receiving via the physical channel, during the timeout period, a PHY-RXEARLYSIG indication primitive or a PHYRXSTART indication primitive.

In additional or alternative embodiments, the first STA may comprise a multiple channel access point (MPC/NPCA AP) STA, and the second channel may comprise an auxiliary channel. In an embodiment, process 2300 may further comprise, after the receiving of the first frame and before the switching to the auxiliary channel, detecting, from a non-MPC/non-NPCA non-AP station, a communication via the primary channel. In an embodiment, the second STA may comprise an MPC/NPCA non-AP STA that switched to the auxiliary channel upon concurrent receipt of the first frame with the MPC/NPCA AP STA, and the second frame may comprise an indication frame, with the indication frame indicating to the MPC/NPCA non-AP STA that the auxiliary channel is available for communication with the MPC/NPCA AP STA. In an embodiment, the indication frame comprises a downlink (DL) frame. In an embodiment, the indication frame may indicate to the MPC/NPCA non-AP STA that the MPC/NPCA AP STA has performed a media channel synchronization on the auxiliary channel. In an embodiment, the indication frame may comprise a trigger frame.

In additional or alternative embodiments, the first STA may comprise a MPC/NPCA non-AP STA, and the second STA may comprise a MPC/NPCA AP station, and the second channel may comprise an auxiliary channel. In an embodiment, process 2300 may further comprise, based on the indication and upon receipt of the first frame concurrently with the MPC/NPCA AP station, switching to the auxiliary channel. In an embodiment, process 2300 may further comprise, receiving an indication frame via the auxiliary channel, wherein the transmitting of the second frame is based on the trigger frame. In an embodiment, the indication frame may have been transmitted by the MPC/NPCA AP station and indicates to the MPC/NPCA non-AP station that the auxiliary channel is available for communication. In an embodiment, indication frame indicates that the MPC/NPCA AP STA has performed a media channel synchronization on the auxiliary channel. In an embodiment, the indication frame may comprise at least one of, a management frame, a clear to send (CTS) frame, a block acknowledgement request (BAR) frame, and null data packet (NDP) announcement frame.

What is claimed is:

1. A method comprising:
receiving, by a first station (STA) from a second STA and via a first channel, a first frame comprising an indication of a frame type of the first frame; and
after receiving the first frame and based on the indication of the frame type, switching a channel of operation of the first STA, from the first channel to a second channel,
wherein the switching occurs after a timeout period that commences after receiving the first frame,
wherein the timeout period is based on the indication of the frame type of the first frame, and
wherein the first STA comprises a non-primary channel access (NPCA) STA, the first channel comprises a primary channel (PCH), and the second channel comprises an auxiliary channel.

2. The method of claim 1, wherein the timeout period comprises a duration for which the first STA continues to operate on the first channel after receiving the first frame.

3. The method of claim 2, wherein the frame type of the first frame comprises a request to send (RTS) frame or a multi-user request to send (MU-RTS) frame.

4. The method of claim 3, wherein a duration of the timeout period is based on the first frame indicating that it comprises the RTS frame or MU-RTS frame.

5. The method of claim 4, wherein the duration of the timeout period is based on a duration of a clear-to-send (CTS) frame relating to the RTS frame or MU-RTS frame.

6. The method of claim 1, wherein the method further comprises receiving, by the first STA, a third frame via the first channel, and wherein the switching of the channel of operation to the second channel occurs after the receiving the third frame.

7. The method of claim 6, wherein the first channel corresponds to a physical channel of a physical layer (PHY) associated with the first channel, and wherein the receiving of the third frame comprises, receiving via the physical channel, during the first duration, a PHY-RXEARLYSIG indication primitive or a PHYRXSTART indication primitive.

8. A first station (STA) comprising:
one or more processors; and
memory storing instructions that, when executed by the one or more processors, cause the first STA to:
receive, from a second STA and via a first channel, a first frame comprising an indication of a frame type of the first frame; and
after receiving the first frame and based on the indication of the frame type, switch a channel of operation of the first STA, from the first channel to a second channel,
wherein the switching occurs after a timeout period that commences after receiving the first frame,
wherein the timeout period is based on the indication of the frame type of the first frame, and
wherein the first STA comprises a non-primary channel access (NPCA) STA, the first channel comprises a primary channel (PCH), and the second channel comprises an auxiliary channel.

9. The first STA of claim 8, wherein the timeout period comprises a duration for which the first STA continues to operate on the first channel after receiving the first frame.

10. The first STA of claim 9, wherein the frame type of the first frame comprises a request to send (RTS) frame or a multi-user request to send (MU-RTS) frame.

11. The first STA of claim 10, wherein a duration of the timeout period is based on the first frame indicating that it comprises the RTS frame or MU-RTS frame.

12. The first STA of claim 11, wherein the duration of the timeout period is based on a duration of a clear-to-send (CTS) frame relating to the RTS frame or MU-RTS frame.

13. The first STA of claim 8, wherein the instructions further cause the first STA to receive a third frame via the first channel, and wherein the switching of the channel of operation to the second channel occurs after the receiving the third frame.

14. The first STA of claim 13, wherein the first channel corresponds to a physical channel of a physical layer (PHY) associated with the first channel, and wherein the receiving of the third frame comprises, receiving via the physical channel, during the first duration, a PHY-RXEARLYSIG indication primitive or a PHYRXSTART indication primitive.

15. A non-transitory computer-readable medium comprising instructions that, when executed by one or more processors of a first station (STA), cause the first STA to:
receive, from a second STA and via a first channel, a first frame comprising an indication of a frame type of the first frame; and
after receiving the first frame and based on the indication of the frame type, switch a channel of operation of the first STA, from the first channel to a second channel,
wherein the switching occurs after a timeout period that commences after receiving the first frame,
wherein the timeout period is based on the indication of the frame type of the first frame, and
wherein the first STA comprises a non-primary channel access (NPCA) STA, the first channel comprises a primary channel (PCH), and the second channel comprises an auxiliary channel.

16. The non-transitory computer-readable medium of claim 15, wherein the timeout period comprises a duration for which the first STA continues to operate on the first channel after receiving the first frame.

17. The non-transitory computer-readable medium of claim 16, wherein the frame type of the first frame comprises a request to send (RTS) frame or a multi-user request to send (MU-RTS) frame.

18. The non-transitory computer-readable medium of claim 17, wherein a duration of the timeout period is based on the first frame indicating that it comprises the RTS frame or MU-RTS frame.

19. The non-transitory computer-readable medium of claim 18, wherein the duration of the timeout period is based on a duration of a clear-to-send (CTS) frame relating to the RTS frame or MU-RTS frame.

20. The non-transitory computer-readable medium of claim 15, wherein the instructions further cause the first STA to receive a third frame via the first channel, wherein the switching of the channel of operation to the second channel occurs after the receiving the third frame, wherein the first channel corresponds to a physical channel of a physical layer (PHY) associated with the first channel, and wherein the receiving of the third frame comprises, receiving via the physical channel, during the first duration, a PHY-RXEARLYSIG indication primitive or a PHYRXSTART indication primitive.
